(19) United States
(12) Patent Application Publication
(10) Pub. No.: US 2024/0245985 A1
(43) Pub. Date: Jul. 25, 2024

(54) GAME DEVICE AND ASSOCIATED METHODS

(71) Applicant: Core PD Limited, Glasgow, Strathclyde (GB)

(72) Inventor: Josh REID, Glasgow, Strathclyde (GB)

(21) Appl. No.: 18/566,399

(22) PCT Filed: Jun. 1, 2022
(86) PCT No.: PCT/GB2022/051409

§ 371 Date: Dec. 1, 2023

(30) Foreign Application Priority Data
Jun. 4, 2021 (GB) 2108051.0

(51) Int. Cl. A63F 9/24

(52) U.S. Cl. CPC A63F 9/24; A63F 2009/2447; A63F 2009/2451; A63F 2009/247; A63F 2009/2488; A63F 2250/205

(57) ABSTRACT

A portable handheld and/or wearable screenless electronic game (10) device with at least one proximity sensor. The proximity sensor detects a proximity of the game device (10) to an object (10b) and/or detects a proximity of the object (10b) to the game device (10), such that the game device (10) detects a relative proximity between the game device (10) and the object (10b). The game device (10b) changes game state or configuration in dependence on a proximity trigger signal, the proximity sensor providing the proximity trigger signal when the object (10b) is detected within a minimum threshold relative proximity to the game device (10).

The present invention relates to the technical field of toys. More particularly, the present invention relates to an electronic game device, especially an array of devices, and methods of operation of the device for playing one or more games played by a single player and/or by multiple players.

### BACKGROUND

Children playing tag and chase games are often disrupted by arguments about who was tagged and who was not; and deciding on who is the tagger can be unfair and lead to breakdowns of the games. Although there are many existing variations in the games of tag, most of them are variations on a few basic themes and these lack an engaging element to attract children whom may generally be less interested in physical games.

Parents often want to encourage their children to be physically active and schools and governments have the same objective to avoid an obesity epidemic among young people. Many children in many countries around the world are not reaching recommended weekly activity levels: According to public health England in 2020, just 23% of boys and 20% of girls meet the national recommended level of activity.

It may be an object of one or more aspects, examples, embodiments, or claims of the present disclosure to at least mitigate or ameliorate one or more problems associated with the prior art, such as those described herein or elsewhere.

According to an aspect of the present disclosure, there is provided a game device. The game device may comprise at least one sensor. The at least one sensor may comprise a proximity sensor. The proximity sensor may be configured to detect a proximity of the game device to an object. Additionally or alternatively the proximity sensor may be configured to detect a proximity of the object to the game device. The proximity sensor may be configured to detect a relative proximity between the game device and the object. The game device may be configured to change game state or configuration in dependence on a trigger. The trigger may comprise a sensor trigger. The trigger may comprise a proximity trigger. For example, the proximity sensor may provide a trigger signal when the object is detected in relative proximity to the game device.

Detecting the proximity may comprise sensing the object is within a threshold. The threshold may comprise a minimum threshold. The threshold may comprise a distance range of the game device. The threshold may comprise a temporal element. For example, the threshold may comprise the object being within a minimum distance range of the game device, optionally for a minimum length of time.

The object may comprise a second game device. Accordingly, a first game device may be configured to detect a proximity of a second game device relative to the first game device. In at least some examples, the first game device may be configured to detect the second game device when it is within the proximity threshold of the first game device. The second game device may be configured to detect the first game device when it is within a second proximity threshold, the second proximity threshold being that associated with the second device. The proximity threshold of the first device and the second proximity threshold of the second device may be the same. For example, the proximity threshold of both devices may be configured to be triggered by a same signal strength and/or relative distance therebetween. Accordingly, the first and second devices may be configured to be triggered simultaneously based upon their proximity to each other. In other examples, the first and second devices may be configured to be triggered differently, such as whereby the first and second proximity thresholds are different. For example, the first device may be configured to be triggered at a first proximity threshold corresponding to a lower signal strength and/or greater distance relative to the second device that may be configured to be triggered by a second proximity threshold corresponding to a higher signal strength and/or lesser distance.

In at least some examples, the proximity trigger may comprise an additional element, such as detection of a suitable signal (e.g. strength) and/or object. For example, the proximity trigger may require mutual detection. The step of proximity detection may comprise an identification element. The proximity trigger may require mutual proximity detection prior to performing an action based upon the proximity trigger. For example, in a game whereby a role and/or score of each device (e.g. a first device and a second device coming into proximity) is dependent upon a proximity event, then mutual proximity detection may ensure fair or synchronised triggering (e.g. that one user is not disadvantaged by having a stronger emitted signal or a weaker signal detection). For example, where a game involves a transfer of role (e.g. as in conventional tig or tag where the role of tigger or tagger is transferred by a tig/tag event), then two-way communication of that detection between the pair of game devices may be required for mutual confirmation of proximity. Mutual proximity detection may help ensure an equity in games. For example, where a first device coincidentally has a stronger signal than a second device, the user of that first device is not disadvantaged (or advantaged) by being detected at a greater distance (e.g. earlier) than the user of the second device.

The proximity threshold may be configurable or reconfigurable. For example, the proximity threshold may be configured in dependence on a game or type of game being played; and/or a role and/or phase in the game being played with the device. The proximity threshold may be configured to vary automatically, such as in dependence upon a variation in game and/or role. Additionally, or alternatively, the proximity threshold may be manually adjustable. For example, the user or a master user/controller may be able to manually adjust proximity threshold

The proximity threshold may comprise a default threshold. The proximity threshold and/or default threshold may be similarly configured for a plurality of devices. For example a pair of game devices may be configured with similar (default) proximity thresholds.

The proximity may comprise a three-dimensional proximity. For example, the game device may be configured to detect the proximity of the object in any direction horizontally and/or vertically relative to the game device.

In at least some examples the proximity sensor may comprise a wireless sensor. The wireless sensor may comprise at least one of: a wireless receiver; and/or a wireless transmitter. The wireless sensor may comprise an antenna or antennae. The antenna/e may be configured to detect or receive a wireless signal. The antenna/e may be configured to detect or transmit a wireless signal. The wireless signal may comprise a short-range wireless or wi-fi signal, such as Bluetooth™. The proximity sensor may comprise a near-field Bluetooth™ antenna.

The game device may be configured to assist and/or ensure compliance with minimum player separation. For example, the game device/s may at least assist in social distancing of players. For example, the game device/s may be configured to allow approximation of ‘contact sports’, such as rugby, football, American football, handball, basketball or the like, without, or at least with reduced, risk of contact or close contact.

The game device may be configured to change status based upon the trigger. The trigger may comprise an event. The event may be associated with a change in status and/or role of the game device and/or game being played. For example, the event may comprise a change in phase of the game, such as ending the game. The event may be associated with a movement of the player/s and/or game device, such as an absolute movement of the game device (e.g. rotation, tilting, etc.) and/or a relative movement of the device (e.g. relative to another object, such as another game device). The event may be associated with activation and/or a threshold of the game device's sensor/s. The trigger may be associated with a relative proximity of the game device. The proximity may be determined based upon the proximity sensor of the game device and/or of another object (e.g. another game device and/or an external control device).

The status or configuration of the game device may be indicated. The status or configuration may be visually indicated. Additionally, or alternatively, the indication may comprise audio and/or haptic indication. The visual indicator may comprise an emission of light. The status or configuration may be continuously indicated. Alternatively, the status or configuration may be temporarily or periodically indicated. The indication may be multidirectional. The indication may be omnidirectional.

The game device may be configured to provide an omnidirectional visual indicator. The light source/s may be controlled to provide indication of the game device's (user thereof) status to other players—and/or also directly to the user holding or using that game device. Indication may be in the form of one or more of, such as combinations of: coloured light; pulsed or flashing light; combinations of colours of light.

The change in status may be indicated by the indicator.

Additionally or alternatively, the trigger event may comprise a movement or action with or on the game device. For example, the trigger event may comprise a change in orientation of the game device, such as between vertical and horizontal; and/or rotation about an axis (e.g. rotation about an imaginary vertical axis). The trigger event may comprise an event associated with a user gesture.

The at least one sensor may comprise a movement or motion sensor, such as one or more accelerometers and/or gyro sensors or gyroscopes.

In at least some examples, the game device may be configured or configurable to play games entirely solo with a single game device. For example, a single game device may be configurable to play games requiring the user/player to perform actions; especially actions in a particular sequential order. For example, the game device may instruct the user to perform one or more of: “shake”, “twist”, “throw”, “run”, “bounce”, “jump”, “spin”, etc. The game device may emit audio and/or haptic and/or visual instructions. For example, a particular colour of the game device may correspond to a particular action (e.g. game device changing to a first colour, or flashing a first colour, or colour sequence, may correspond to a first action, such as “shake”, and a second colour signal may correspond to a second action, such as “throw”). The instructions may be multimodal (e.g. an audio instruction may accompany a corresponding visual and/or haptic instruction signal).

The game device may comprise a portable electronic game device. The game device may comprise a handheld and/or wearable game device. In at least some examples, the game device may be configured to be held in one and/or two hands; and also worn, such as on an arm, leg, torso or the like. The game device may be attachable. The game device may be attachable with an accessory, such as a strap, band, garment or the like.

The game device may be configured for holding by a hand. The game device may be sized and dimensioned for holding in a single hand, particularly that of a young child. The game device may comprise a gripping portion with a circumference of 8 cm or less.

The game device may be configured for gripping by hand. For example, the game device may comprise a relatively high coefficient of friction with skin. The game device may be configured for gripping by hand in both dry and wet conditions.

The game device may comprise a discrete electronic device. The game device may be configured for use only in proximity-based games, the proximity-based games being dependent on the physical proximity of the actual device relative to another object, such as a second game device. The game device may not be configured or configurable for other non-game uses. For example, in contrast to devices such as mobile telephones, tablets, the game device may be solely configured for playing physical games, involving physical movement/translation of the game device and/or user.

The game device may be devoid of a graphical user interface. The game device may comprise a screenless device. The game device may be devoid of a manual input interface, such as by keypad, keyboard, touchscreen, touchpad, with the direct user of the game device. The game device may be devoid of a direct programmable control input for the user of the/that game device to directly control the game device. The game device, optionally an array of game devices, may be configured for use without providing and/or requiring any display or screen-based feedback. In contrast, to devices such as games console controllers, the game device/s of the present disclosure enable entirely screen-free games.

The game device may comprise an activation means, such as a power or ON/OFF switch. The game device's only control interface, such as mechanical switch, with the direct user of that game device may consist of the power or ON/OFF switch. Additionally, or alternatively, the game device may be controlled or at least partially programmable (e.g. for game and/or role selection; and/or starting/ending games) by movement, such as relative movement, of the game device and/or voice activation. For example, a game may be selected and/or initiated and/or terminated based upon an input detected by one or more of the sensor/s (e.g. proximity, rotation, tilting, tapping, etc). A different input or different sequence of inputs (from one or more of the sensor/s) may be associated with a different command or selection.

The game device may be configured to be locally networked, such as with a second game device and/or an external device. The game device/s may be configured to be intermittently networked during a game, such as when sufficiently proximal to another game device and/or the external control device. The game device/s may be configured to wirelessly connect and/or disconnect prior to and/or during a game, such as to another game device/s and/or the external control device/s. Additionally, or alternatively, the game device/s may be configured to be continuously wirelessly connected prior to and/or during a game/s, such as to another game device/s and/or the external control device/s. In at least some examples, the game device/s is continuously wirelessly connected (e.g. via WiFi/WLAN) and also intermittently connected, or at least intermittently in wireless contact, such as via a different wireless signal (e.g. WPAN/Bluetooth™).

The device may comprise a wireless transmitter and/or receiver for transmitting data or communicating with at least one other device and/or a controller, such as an external control or programming apparatus. The device may comprise a wireless transmitter/receiver in addition to the proximity sensor/s. In at least some examples, the wireless transmitter/receiver may comprise a further short-range wireless transmitter/receiver. The wireless transmitter/receiver for transmitting data may comprise a WLAN transmitter/receiver, such as in conformance with an IEEE 802.xx standard (e.g. IEEE 802.11ax-2021 or 802.11ax) or WiFi 6e of WiFi Alliance. In at least some examples, the game device/s may be configured for both wireless WiFi/WLAN signal receipt/transmission and also Bluetooth™/WPAN signal receipt/transmission.

The device may be configured for communication with an external device, such as an external controller or programming apparatus. The external device may comprise one or more of: a mobile phone; a computer; a bespoke control device. The external device may comprise an external control device. The external device may comprise a screen. The game device may be operable in game mode/s without requiring a presence of the external device. The game device may be operable in game mode/s without requiring communication with the external device. The game device may be operable to play game/s without requiring feedback or output from the external device. In contrast to, for example, games consoles controllers, the game devices here do not require any output or feedback from a screen, display, headset or the like.

The operation, such as mode of operation (e.g. type of game and/or game parameters, of the game device/s, singularly and/or in networked configuration, may be adaptable. The operation may be selectable. The operation may be selectable by directly by the game device's user and/or indirectly by a master user, such as a remote master user via the external control device. The operation may be selectable by the game device/s directly and/or via the external device. The game device/s may be initially configured or programmed by the external device. The external device may comprise an electronic device, such as a mobile cellphone, tablet, or the like, which may communicate wirelessly with the game device/s. The game device/s may be initially configurable by the external device, such as to select and/or define a predefined game for which the game device is then configured. For example, the game device may comprise set/s of instruction/s in its memory corresponding to a plurality of game modes. The game modes may be provided in a sequential order, such as with an initial default game mode corresponding to a first game (e.g. “copycat” type game mode); and a next selected game mode corresponding to a second game mode (e.g. “treasure hunt” game mode); and optionally further game modes. The game modes may be selectable by incrementally scrolling/toggling through the modes sequentially (e.g. with an action or function of the game device directly). Alternatively, the game mode may be selected directly, non-sequentially. For example, the external device may comprise a screen for selecting the desired game mode from a list.

In at least some examples, the operation and/or game mode/s of the device/s may be individually customisable. The customisation may be via a user interface, such as provided graphically via the external device. For example, the user may be able to select a type of game, number of users, game parameters (e.g. time windows, tolerances, etc) from a menu/s. Additionally, or alternatively, the game device may be customisable by adapting or creating a control programme to control operation of the game device. For example, a user may be able to programme or code a control programme for the game device/s. Accordingly, the user may be encouraged to code.

The game device/s may provide advantages over previous toys or game devices, such as to take tag games to a new level with fun variations and exciting additional features. Additionally, the game device may provide a platform for playing other games. Each game device may effectively comprise an electronic ball. The game device/s may be configured to orchestrate the games, define and enforce the rules, and add additional excitement and variation. The present inventor has identified that the most engaging and inclusive games tend to be those that combine skill and physical ability with an element of chance, meaning that even a novice or not as physically gifted person can engage and have fun because they have a chance of winning games played with the presently-disclosed game device. In at least some examples, the game device is configured to allow physical games with reduced physical contact compared to conventional physical games without use of such a game device as hereby disclosed. Less physical contact may enable socially-distanced playground activities, such as during times when viruses may otherwise be spread by traditional playground games.

The game device may be configured to assist in maintenance of social distancing, such as advised or mandated. For example, where virus guidance or regulations stipulate that people (e.g. in an outdoor and/or indoor setting) should/must maintain a minimum separation distance (e.g. 1 m, 1.5 m or 2 m respectively), then the game device may be configured to assist in ensuring such separation. The game device may enable physical games with multiple players that may otherwise be prohibited or at least contrary to advice/guidance, such as due to requirements/advice to maintain a (social) distance to mitigate virus spread.

The game device/s may provide advantages over a phone or smartwatch or the like. For example, tablets and cell phones have screens and a lot of other functionality that could distract from a core purpose of the game device disclosed here, which may be to encourage physical activity. The game device disclosed hereby may be configured to encourage users to move; and to discourage users from looking at display screens. In contrast to phones or generic device that can be used for calls, social media and screen-based video games, users of the presently-disclosed game device/s are not presented with such functionality or temptations that could otherwise make it likely that children would cease the physical activity and revert to the other things that phones/generic devices can do.

The omni-directional indication of the game device may be used to indicate the player's status to other players (e.g. they are on green team or red team or they are the tagger, they are stuck etc). This is in general contrast to phones/generic devices, whereby at least such omnidirectional visual indication is not so available (e.g. the lights on the front of phones are usually white as they are used primarily for illuminating objects that will be photographed, etc.).

The presently-disclosed game device may comprise a relatively lighter and/or relatively more grippable device than a cellphone or similar. The presently-disclosed game device may comprise a relatively more robust and/or less expensive/valuable and/or relatively less complex device than a cellphone or similar. The presently-disclosed game device may comprise a relatively straightforward setup compared to a cellphone or similar (e.g. a corresponding or equivalent cellphone WPAN/WLAN etc. could be cumbersome—getting all users onto the same network, same app etc.).

The presently-disclosed game device may comprise a proximity detection using Bluetooth; and a wifi-connection for transferring data within the game network (e.g. between game devices and/or the external control device). The presently-disclosed game device may comprise a defined aerial placement for the proximity sensor. The aerial/antenna/e may be located such that the aerial antenna/e is not masked by the user (e.g. to avoid or at least mitigate adverse effects on proximity detection). The aerial/antenna/e may be placed at opposite ends of the device (e.g. opposite sides or hemispheres of a ball); and/or comprise a (large/r) aerial/antenna that encompasses a substantial portion of the game device (e.g. a significant portion of a sphere or ball).

The game device may be at least water resistant. The game device may be waterproof. The game device may be rated as waterproof to at least one or more of: IP68, IP6x, IPx8, IPx7, IPx6. All standards and references are taken as of the effective date of this patent application.

According to an aspect, there is provided a method of operating the apparatus according to an aspect, claim, embodiment or example of this disclosure.

According to an aspect, there is provided a method of using the apparatus according to an aspect, claim, embodiment or example of this disclosure.

The steps of the method/s may be in any order.

According to an aspect of, there is provided an apparatus configured to perform a method according to an aspect, claim, embodiment or example of this disclosure.

According to an aspect, there is provided a controller arranged to perform a method according to an aspect, claim, embodiment or example of this disclosure.

According to an aspect, there is provided a system comprising a controller according to an aspect, claim, embodiment or example of this disclosure, or a system arranged to perform a method according to an aspect, claim, embodiment or example of this disclosure.

According to an aspect, there is provided computer software which, when executed by a processing means, is arranged to perform a method according to any aspect, claim, embodiment or example of this disclosure. The computer software may be stored on a computer readable medium. The computer software may be tangibly stored on a computer readable medium. The computer readable medium may be non-transitory.

Any controller or controllers described herein may suitably comprise a control unit or computational device having one or more electronic processors. Thus, the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

Within the scope of this disclosure it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

An embodiment of the present disclosure will now be described by way of example only and with reference to the accompanying drawings, in which:

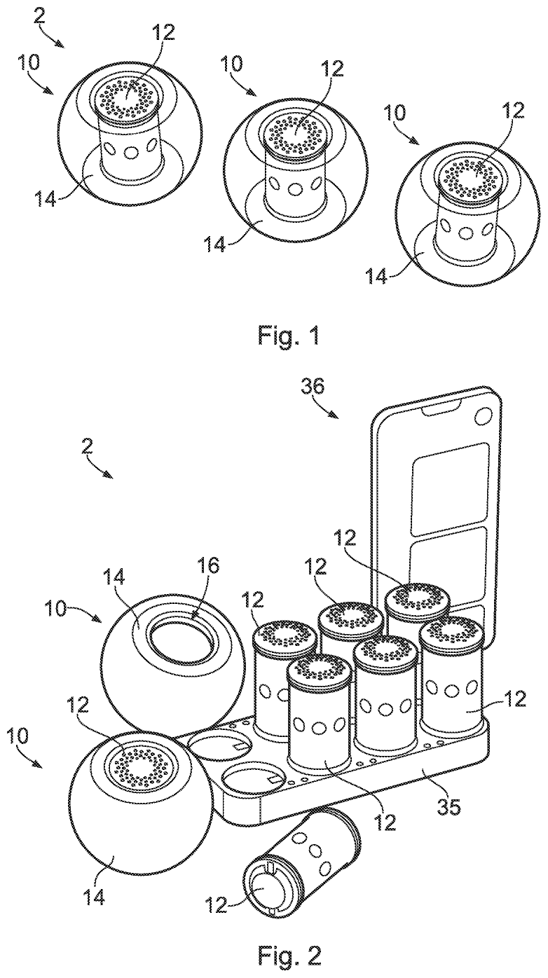

FIG. 1 shows a first example of an array of devices according to the present disclosure;

FIG. 2 shows a charging station for the devices of FIG. 1, together with an external control device;

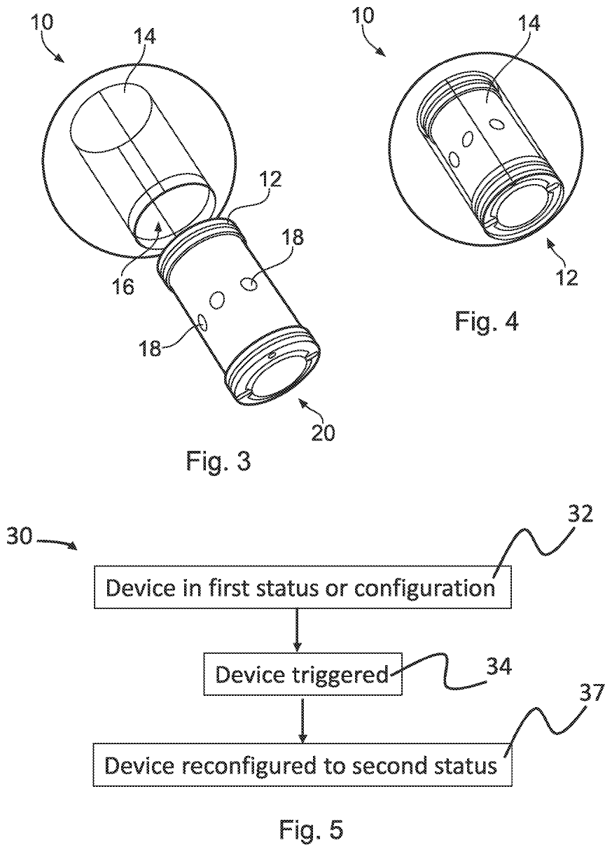

FIG. 3 shows the device of FIG. 1 in a partially-disassembled configuration

FIG. 4 shows the device of FIG. 3 in an assembled configuration;

FIG. 5 illustrates a method according to the present disclosure;

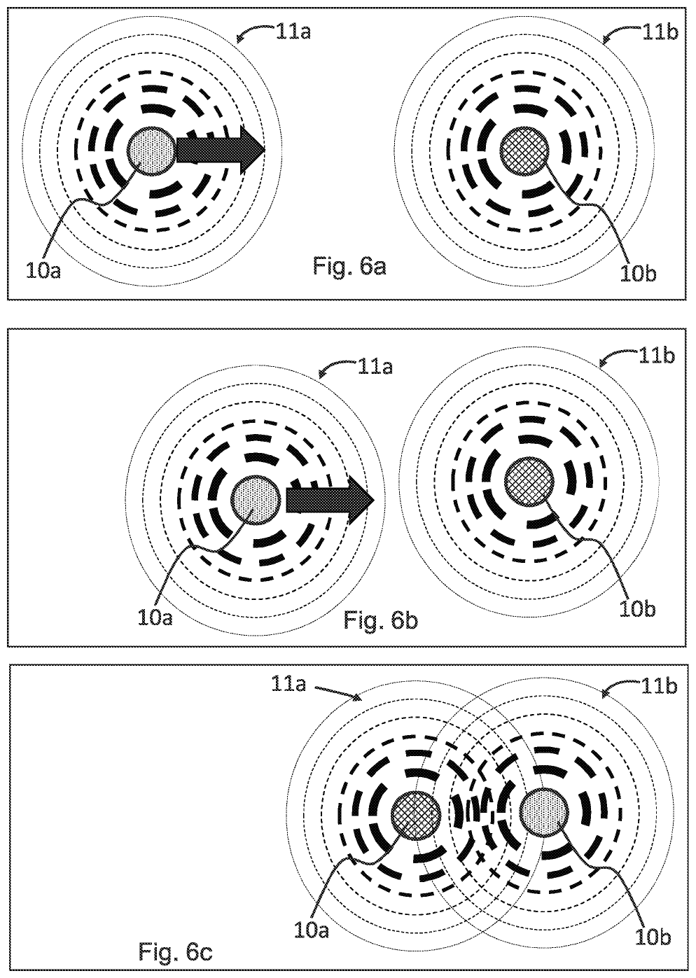

FIGS. 6a, 6b and 6c schematically illustrate a sequence of possible operation of the device of FIG. 3;

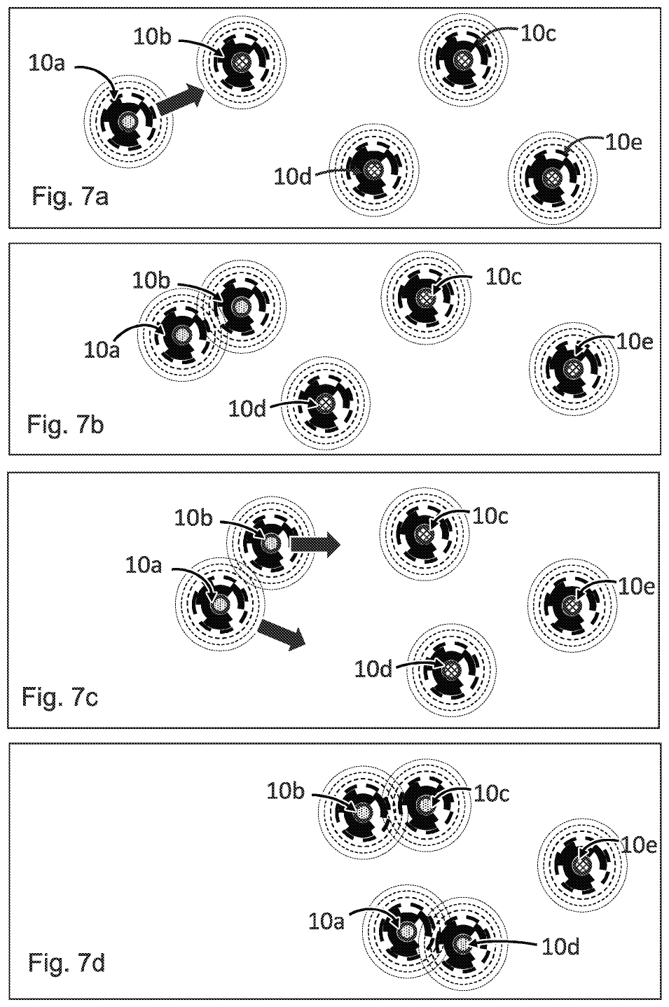

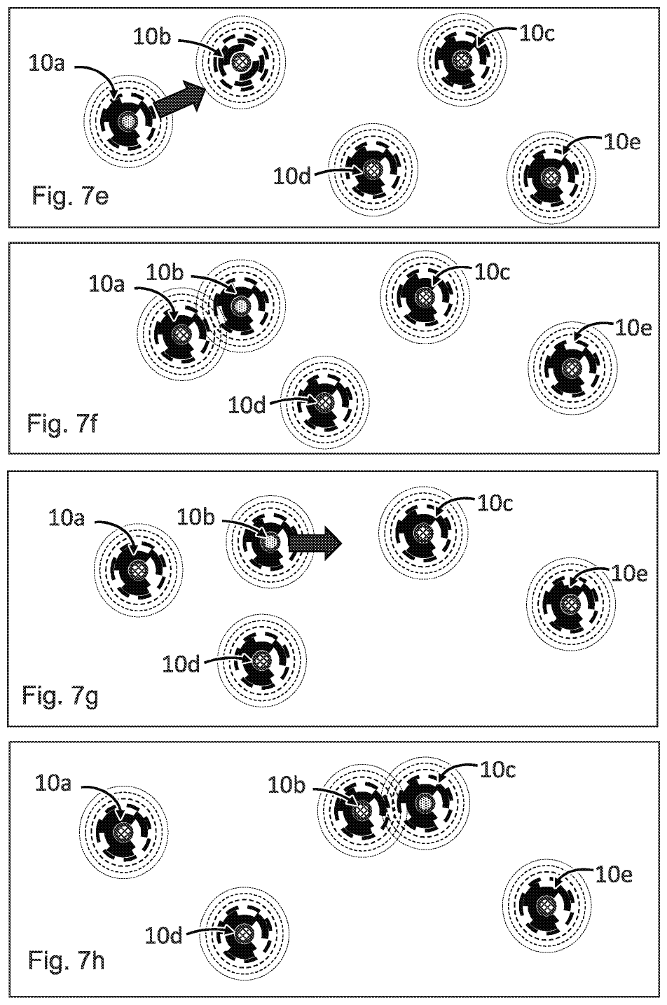

FIGS. 7a, 7b, 7c and 7d schematically illustrate a sequence of a first possible operation of the array of devices of FIG. 1;

FIGS. 7e, 7f, 7g, 7h schematically illustrate a sequence of a second possible operation of the array of devices of FIG. 1;

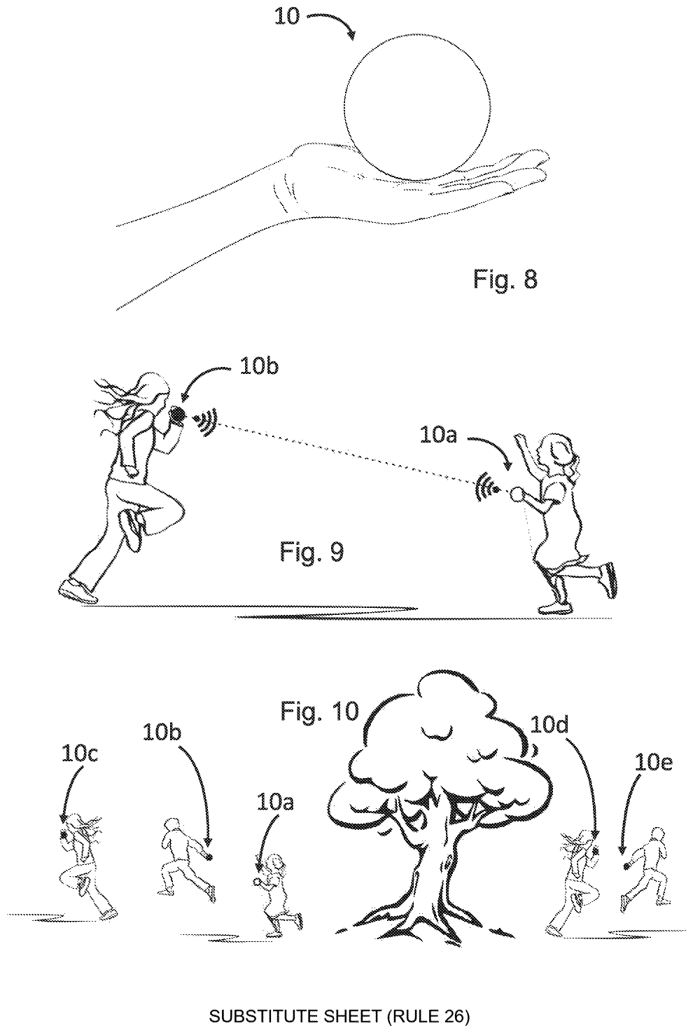

FIG. 8 schematically shows the device of FIG. 1 in a user's hand;

FIG. 9 illustrates a pair of users using two of the devices;

FIG. 10 illustrates a group of users using a plurality of the devices;

FIG. 11 shows a pair of users using two of the devices at a water setting;

FIG. 12 shows a single user using a pair of the devices to play a solo game;

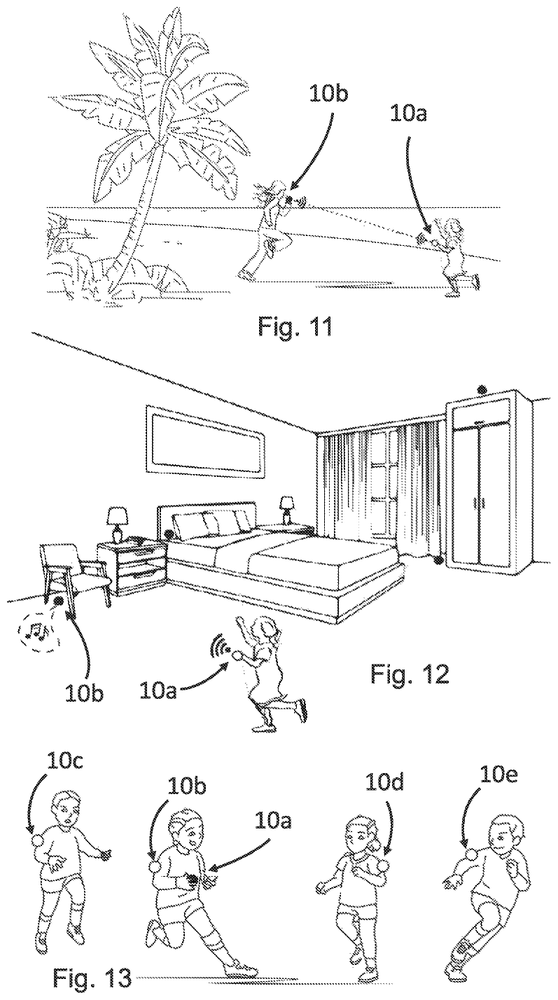

FIG. 13 shows a group of users using a plurality of the devices, including devices in a wearable configuration;

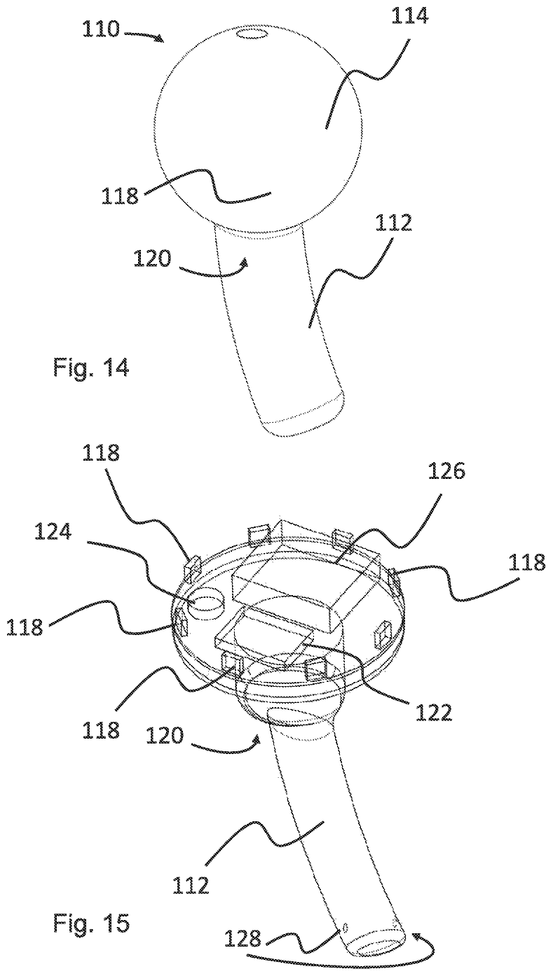

FIG. 14 shows another example of a device according to this disclosure;

FIG. 15 shows a schematic layout of components of the device of FIG. 14;

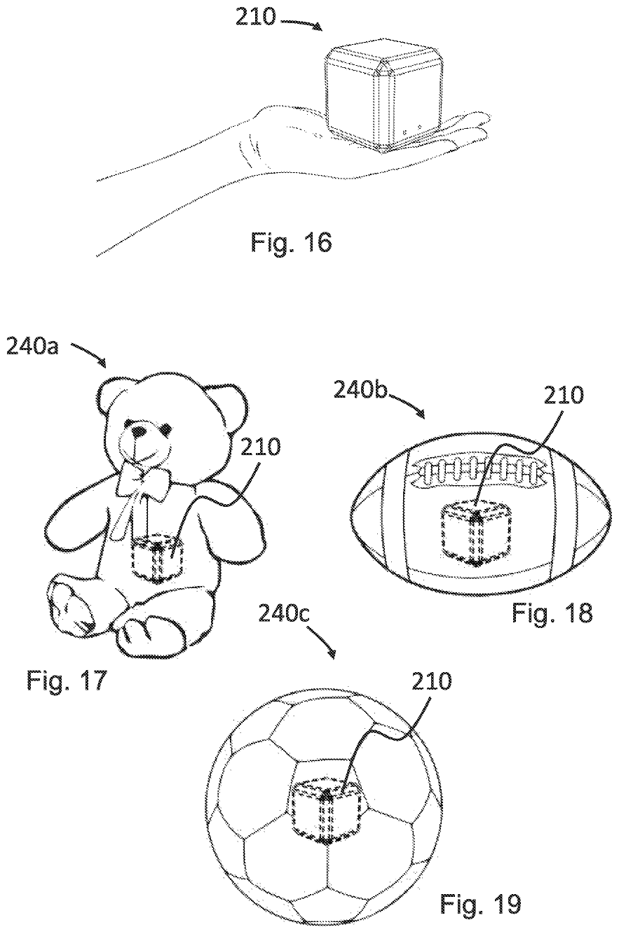

FIG. 16 shows another example of a device according to this disclosure;

FIG. 17 shows the device of FIG. 16 schematically incorporated in an article;

FIG. 18 shows the device of FIG. 16 schematically incorporated in another article;

FIG. 19 shows the device of FIG. 16 schematically incorporated in another article;

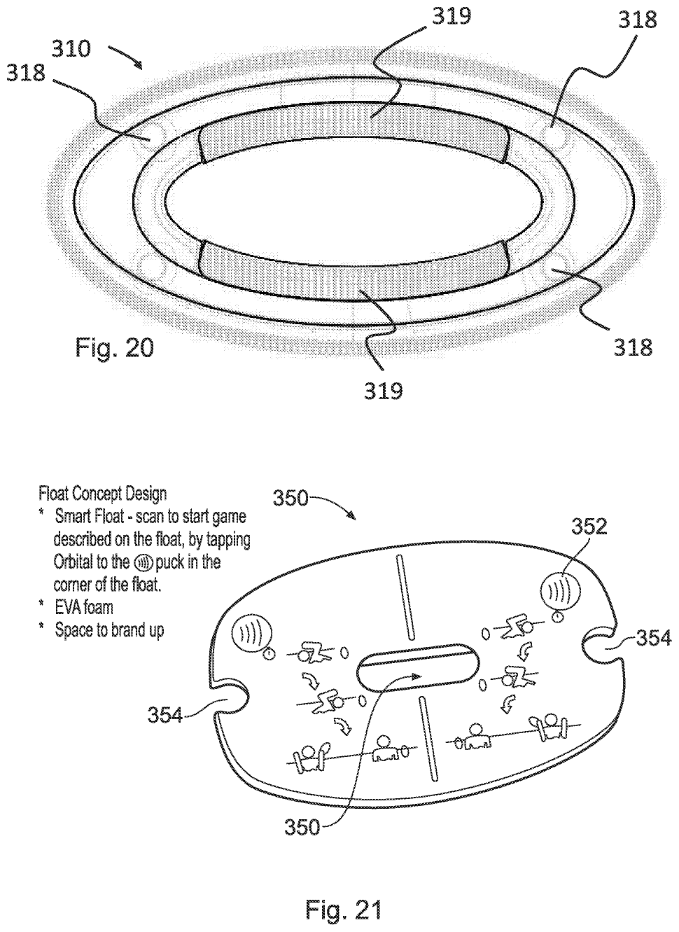

FIG. 20 shows another example of a device according to this disclosure;

FIG. 21 shows an accessory for use with the device of FIG. 21;

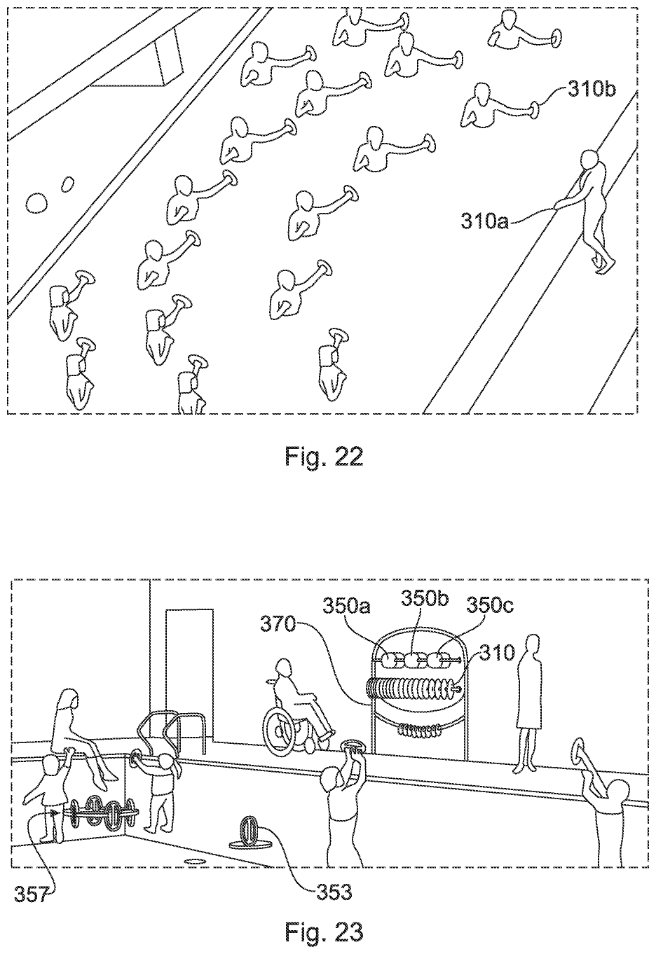

FIG. 22 an array of the devices of FIG. 20 in use in a water setting;

FIG. 23 shows the array of the devices of FIG. 22 in use and also stored with accessories in a storage structure;

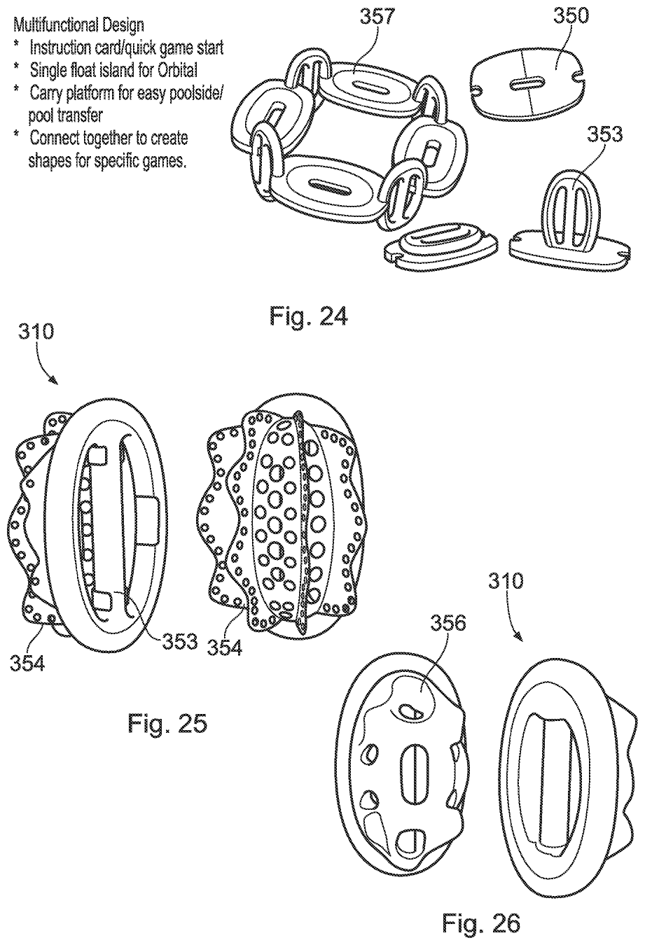

FIG. 24 shows a plurality of the devices of FIG. 20 together with a plurality of the accessories of FIG. 21;

FIG. 25 shows the device of FIG. 20 together with another accessory;

FIG. 26 shows the device of FIG. 20 together with another accessory;

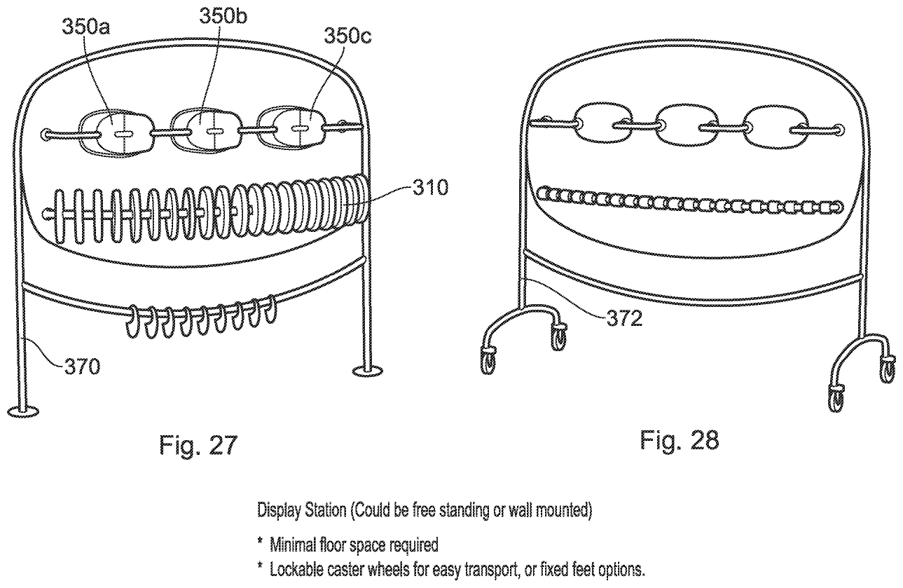

FIG. 27 shows the storage structure of FIG. 23 together with a plurality of the devices of FIG. 20 and a plurality of the accessories of FIG. 21;

FIG. 28 shows a variation on the storage structure of FIG. 27;

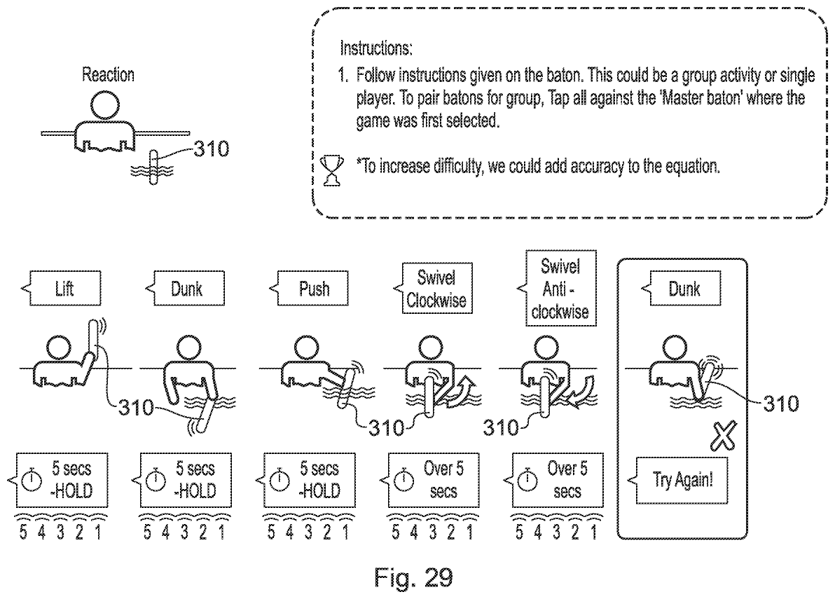

FIG. 29 shows a schematic of a mode or game of use of the device of FIG. 20;

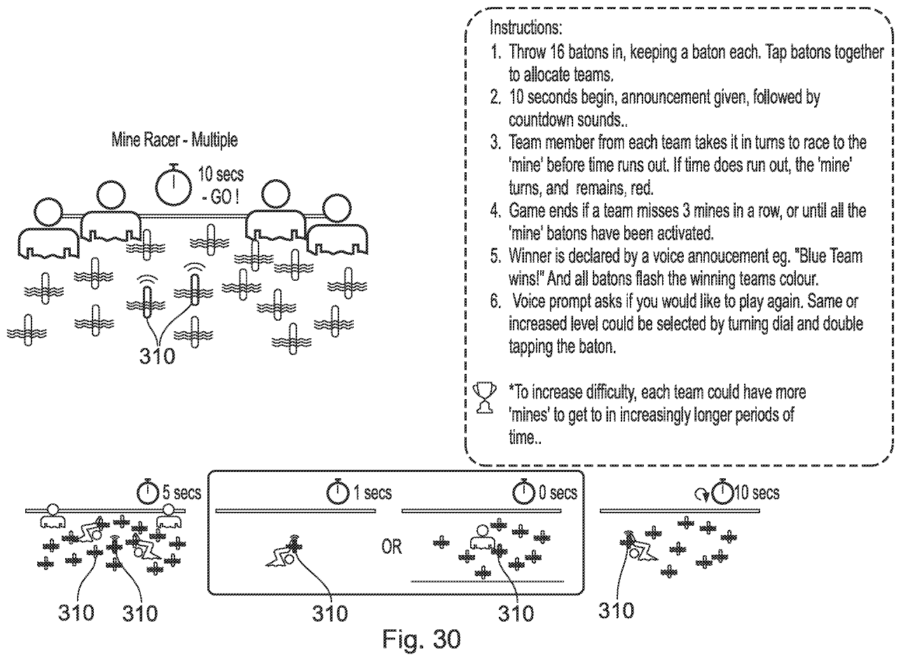

FIG. 30 shows a schematic of a further mode or game of use of a plurality of the devices of FIG. 20;

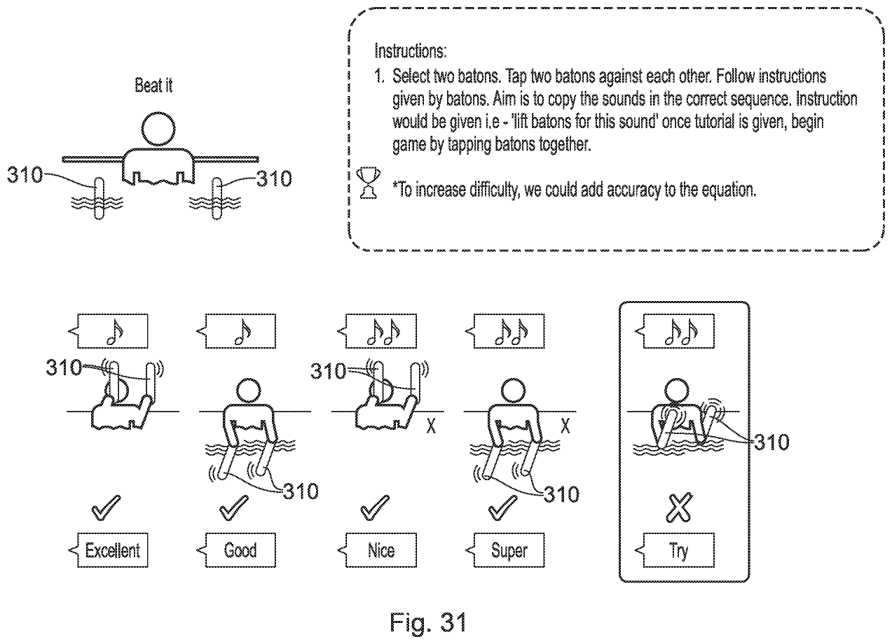

FIG. 31 shows a schematic of a further mode or game of use of a plurality of the devices of FIG. 20;

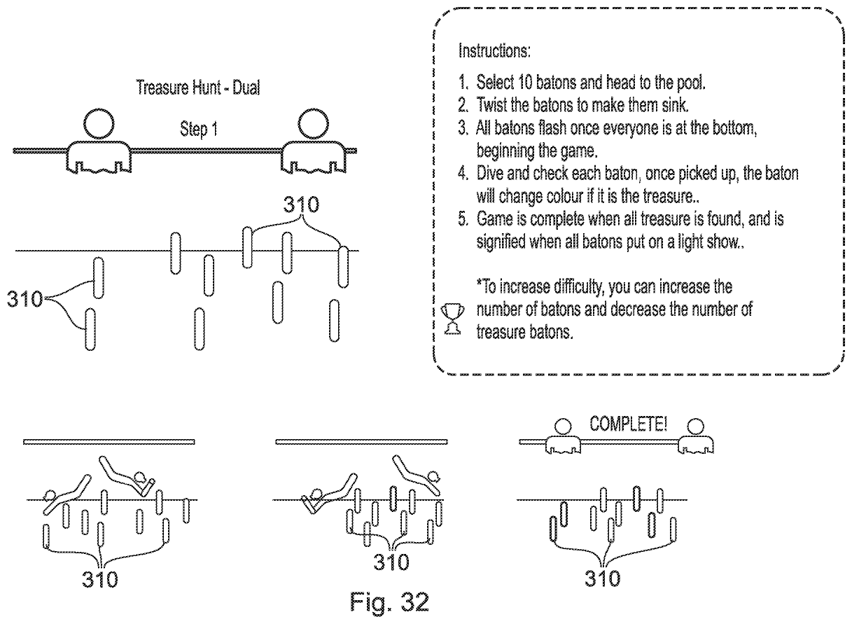

FIG. 32 shows a schematic of a further mode or game of use of a plurality of the devices of FIG. 20;

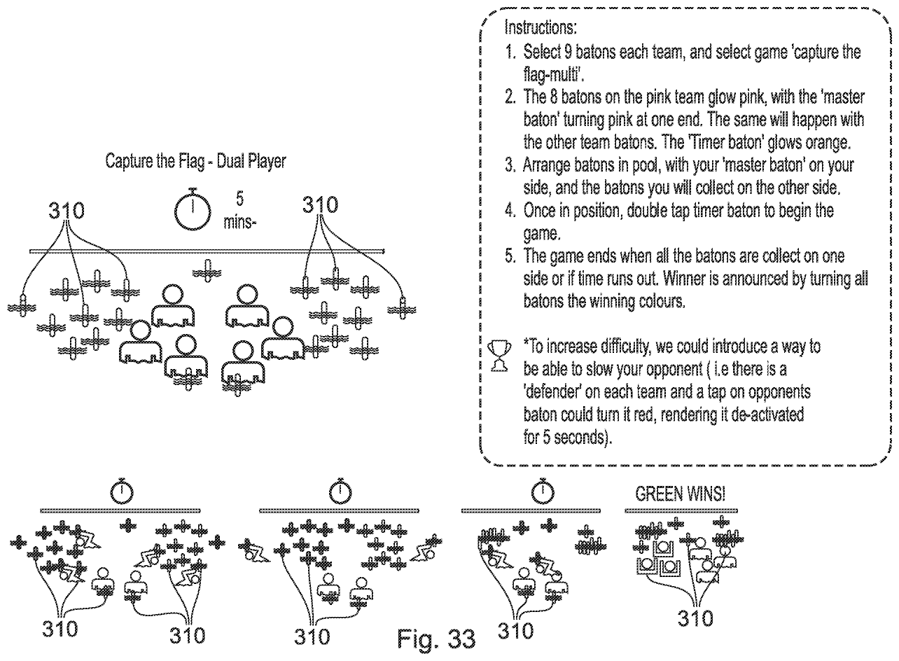

FIG. 33 shows a schematic of a further mode or game of use of a plurality of the devices of FIG. 20;

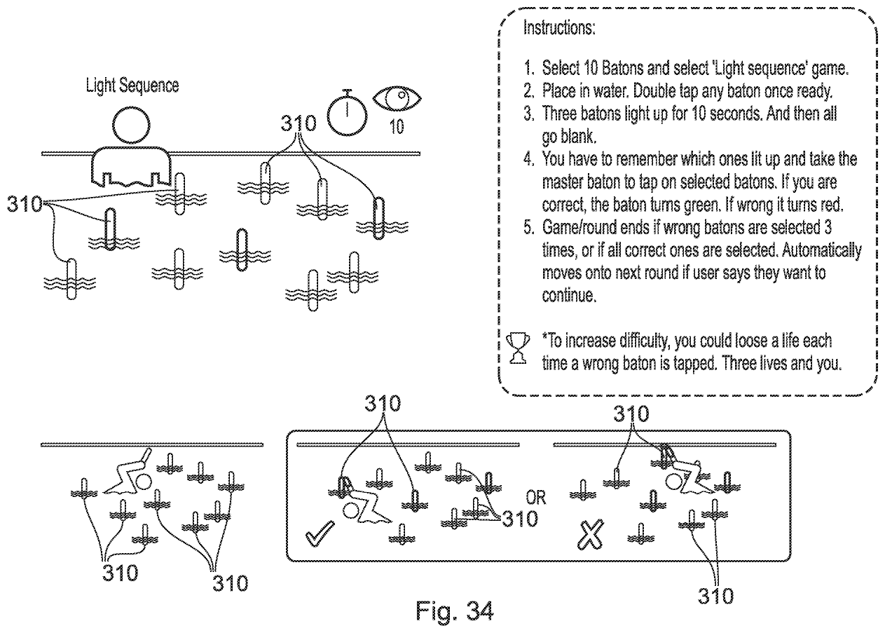

FIG. 34 shows a schematic of a further mode or game of use of a plurality of the devices of FIG. 20; and

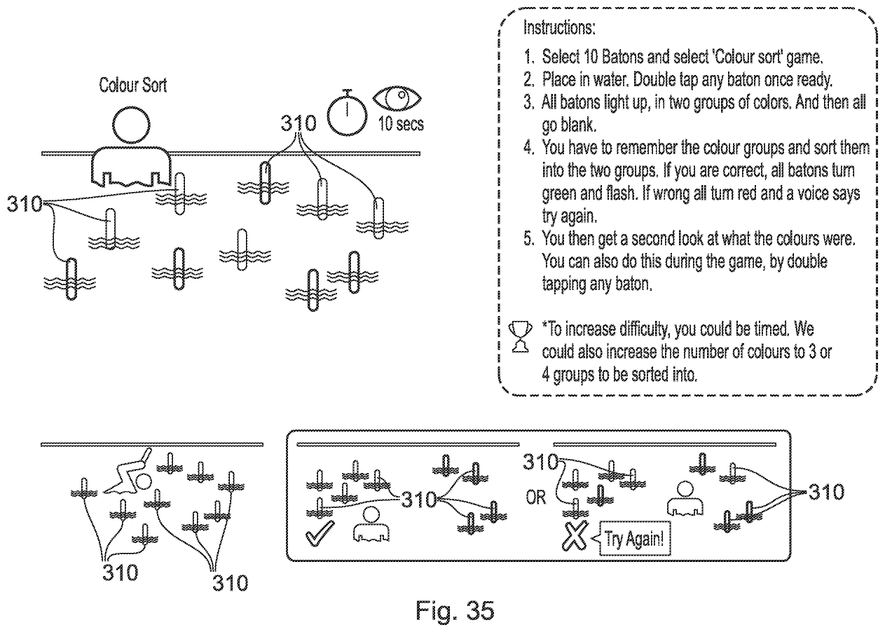

FIG. 35 shows a schematic of a further mode or game of use of a plurality of the devices of FIG. 20.

There is herein described a game device 10 in accordance with an embodiment of the present invention. Referring to FIG. 1 shows a first example of an array of devices 10 according to the present disclosure.

Here, the game devices 10 are configured for both wireless WiFi/WLAN signal receipt/transmission and also Bluetooth™/WPAN signal receipt/transmission. The game devices 10 are configured with proximity sensors. Here, game devices 10 use Bluetooth beacons to detect the proximity of other game devices 10. The Bluetooth does not actually have to establish communications in all game modes. For example, in at least some game modes, it just needs to ‘see’/detect another beacon on a game device 10, detect its strength and then respond to it. The game devices 10 are configured with loudspeakers. In at least some examples, the speakers are configured to indicate changes in game mode, primarily to the player holding the game device 10. In some examples, the speaker is also loud enough to reach far afield players to provide indication to other players. The game devices 10 are configured with omni-directional visual indicators: here, in the form of lights that illuminate the game device 10 (shown here in an orb/sphere form)—to provide indication of the player's status to other players. The game devices 10 are configured with networking ability. Here, the game devices 10 are configured to use wifi to communicate their status to other game devices 10 and/or to a host external controller 36 that is controlling the game. In at least some examples, the networked game devices 10 and/or the external control device 36 decide one or more of: the player status; who is tagged and who is not; when the game is over; and optionally communicate changes in the game to the game device/s 10 involved.

Here, the core of processing and communications is provided by an ESP 32 control module which includes memory, Bluetooth™ (for near field Bluetooth proximity detection), wifi. The game devices 10 are configured with a vibration transducer to indicate changes in game to the player (e.g. to the player holding/wearing the game device 10).

The example game device 10 shown here comprises: Neopixel LED's, Vibration transducer, speaker and a user game selection interface in the form of pushbuttons (not visible). An external control device 36, such as a mobile phone or a tablet with an appropriate app, is required here to setup and select the games. The external control device 36 is not required for the performance of the games; and does not even need to be present (e.g. networked with the game devices 10) for the performance or completion of the games.

FIG. 2 shows a charging station 35 for the devices 10 of FIG. 1, together with an example external control device 36. The charging station 35 is configured to charge multiple devices 10 simultaneously. In the example shown here, each core module 12 of each device is disassembled or detached from the device 10 for charging on the charging station 35. The core modules 12 can be connected for charging, here by simply inverting the core modules 12 and placing on the charging station 35 to dock. The charging station 35 is connected (not shown) to a ‘mains’ electricity source (e.g. 200-240V ac); and recharges the battery/cells in each core module 12 when it is connected in the charging station 35, such as with electrical contact pins or induction charging. In at least some examples, the core modules 12 are charged with aid of magnetic charging clips. Power status of each core module 12 can be indicated on the charging station 35 and/or each core module 12 itself (e.g. using the core module's lighting indicators 18). In at least some examples, power and charging information of each game device 10 is accessible via the external control device 36.

The external control device 36 here is a mobile telephone with a bespoke software or App installed for communication with the devices 10. The external control device 36 can be used before and/or after games, such as to configure games and/or devices 10. For example, the external control device 36 here is used to select the type of game prior to commencement of the game. Here, once selected, the external control device 36 communicates the type of game and the parameters to each of the game devices 10 for the game. For example, each device 10 receives parameters relating to the type of game, the role, at least initially, of that device 10 in the game; and other parameters such as for proximity thresholds (e.g. distance, signal strength, temporal element of proximity threshold). Here, the external control device 36 communicates wirelessly with each game device 10, such as with one of the 802.11 protocols (e.g. 802.11-2020 or earlier). During the game, the game devices 10 communicate with each other using short-range WiFi (Bluetooth™ here), operating effectively as a proximity sensor and also optionally transmitting data between devices, such as to indicate roles, teams, etc. of each respective game device 10. Here, the external control device 36 can be used at the end of the game to check scores or results, depending on the nature of the game selected. The external control device 36 is not required during the performance of the game: all in-game control and feedback is provided directly by the game device 10. For at least some games, the result or score can be indicated without referring to the external control device 36. For example, in games such as “last-man-standing” or elimination-type games, whereby the winner is the last person (game device 10) to remain (e.g. to have their game device 10 remain “uncaught”, in original configuration/colour the longest), then that winner can self-evident by the displayed state of the game device 10 directly (e.g. the last game device 10 of that colour left, such as game device 10e in FIG. 7d).

In at least some examples, the external control device 36 is not required for playing games, with the games being capable of initiated, performed and completed with the game device/s 10 without any input from the external control device 36. For example, the game device/s 10 may be configured or configurable to operate in a default game mode, last-saved in memory game mode or a game mode may be selectable with only a game device 10 or game devices 10—such as based upon actions performed with a game device (e.g. a predefined movement or movements to select a particular game mode or to toggle between game modes; or to scroll sequentially between game modes).

It will be appreciated that multiple control devices 36 can be used with the array of devices 10. For example, different types of external control device, such as mobile telephones, tablets, bespoke external controllers, laptops, etc., can be used to communicate with the array of devices 10.

Information/data on/about each of the game devices 10 can be accessed from the external control device 36. For example, the external game device 10 can provide information on one or more of: power status, game history, positioning history, role history, etc. of each game device 10. The external control device 36 comprises the only graphical user interface here (e.g. touchscreen, display screen and/or keypad) for inputting and/or outputting information from the game devices 10. Here, the game devices 10 as such are devoid of display screens, touchscreens, keypads or programming buttons.

FIG. 3 shows the device 10 in a partially-disassembled configuration. The cores 12 can be disassembled from the housings 14 without requiring any tools. For example, with bayonet-type or screwthread mechanical connections; and/or snap-fits or other mechanical reversible attachments or locks, the core modules 12 can be selectively assembled and disassembled from the housings 14.

The device 10 comprises a speaker 20 in the core module 12 to, for example, indicate changes in game device 10 status or game mode. The speaker 20 is configured to primarily communicate to the player holding the ball. In at least some examples, the speaker 20 is utilised to indicate a/the location of the game device 10. For example, in at least some game modes the speaker 20 can emit a pulsed sound or “beep”. The length of beep and/or interval between beeps may be indicative of a status, such as a location and/or temporal element of the game. For example, the interval may become shorter as a separation distance between the game device 10 to an object (such as a second game device 10) becomes shorter. In at least some games, the speaker 20 may be configured to indicate a location of the game device 10 to other users/players (e.g. not the user/holder of the game device 10, or at least not solely the user/holder of the game device 10). For example, in at least some game modes, the speaker 20 may emit a sound signal to indicate a location of the game device 10 (and its user/holder) to other players. The speaker 20 can emit a sound, such as a regularly-pulsed sound to assist in revealing a location of the game device 10 to other players—such as during blindfold games, standard games, night-time games. The emitted sound may be dependent upon the game device's 10 status or role. For example, multiple game devices 10 operating in a same team may all emit a similar sound; with game devices 10 of an opposing team/s 10 all emitting a different sound. In at least some examples, the emitted sound may comprise spoken word, such as in a default or selected language. The spoken word may be indicative of a game mode and/or game device 10 status. In at least some examples, the speaker 20 provides an indication of the game mode for selection of the game mode by the game device directly 10—such as through a particular or predefined movement, sequence of movement or operation of the game device 10 (or e.g. a touch/push button or the like). For example, as the user effectively scrolls through a range of game modes (e.g. by rotating, shaking or otherwise manipulating the game device 10 in predefined fashion), the speaker 20 audibly indicates the selected game mode/s during scrolling.

The game device 10 also has a haptic indicator (not shown) in the core module 12, such as a haptic motor (vibration transducer) in the core module 12. The haptic indicator is used to indicate status, mode and change/s thereof to the user/holder of the game device 10.

Here, the game device 10 has a gyro/s and accelerometer/s for detecting orientations and movements of the game device 10. These are mounted within the core module 12, along with a PCB control module; which includes memory, Bluetooth™, wifi and rechargeable battery cells.

FIG. 4 shows the device of FIG. 3 in an assembled configuration. The housings 14 provided a protective shield for the core modules 12; helping protect the core modules 12 from impact, water ingress, dirt ingress, etc. In addition, the housings 14 here provide a formed grip, effectively allowing the game device 10 to be gripped in any orientation by a single hand, even of a young child. The housing 14 defines the exterior of the game device 10 as a spherical shape, with a diameter in a range of 7 cm-20 cm. In at least some examples, the game device 10 is provided with a set of multiple housings 14. Accordingly, here the game device 10 has a spherical, ball or orb shape. The core module 12 can be paired with housings 14 of different sizes and/or shapes. For example, a range of spherical housings 14 can be provided, allowing, for example, selection of an optimal size (e.g. spherical diameter) for a particular user and/or game. The surface material of the housing 14 provides a relatively high coefficient of friction with skin, in both wet and dry conditions. Accordingly, the housing 14 assists in ensuring secure grip by users. The housings 14 define light guides, providing light paths from the core module 12 to distribute light evenly around the exterior surface of the housing 14. Accordingly, the housings 14 direct light from the light sources 18 (e.g. LEDs) of the core modules to effectively emit light from the device 10 spherically, such that the game device appears as a glowing orb. The core module 12 has a plurality of light sources 18 arranged evenly around its circumference. The light sources 18 are controlled by a controller in the core module 12. In combination with the light guiding of the housing 14, the light sources 18 provide an omnidirectional visual indicator. Accordingly, the light sources 18 are controlled to provide indication of the game device's 10 (user thereof) status to other players—and also directly to the user holding or using that game device 10. Indication can be in the form of one or more of, such as combinations of: coloured light; pulsed or flashing light; combinations of colours of light. For example, the light source 18 may be configured to constantly emit a particular colour (e.g. red or blue) to indicate a first status or role of the game device 10. A change in status, or a changed status can be indicated by a change in constant colour (e.g. from blue to red). In at least some examples, the light emission may be pulsed or flashing; or may vary between constant and flashing (e.g. to indicate a change in status); and/or the nature of flashing (e.g. pattern, frequency, period, duration of flash, etc.) may be varied. The status of the device 10 may be indicated by a sequence. For example, the sequence may comprise a sequence of different coloured lights and/or pulses (e.g. a number of pulses, indicative of status). The light source may comprise a plurality of types (e.g. different LEDs of different colours) and/or multicolour light source (e.g. multicolour, or tricolour/RGB LED). In at least some examples, or some game modes, the game device may indicate a plurality of colours simultaneously (e.g. one hemisphere may appear as a first colour and the other, second hemisphere as a second, different colour).

Furthermore, the housings 14 here also ensure a spacing between portions of the core module 12 and a user's hand. Accordingly, the housings 14 here help prevent or mitigate shielding of antennae (not shown) in the core modules 12. In at least some examples, the core module 12 has an arrangement of antennae to also mitigate shielding by a user's hand/s. For example, pairs of differently oriented antennae in the core module 12 can mitigate against shielding of one of the antennae by a hand/s.

FIG. 5 illustrates a method according to the present disclosure. In a simple operation mode, the game device 10 starts a game in a first status or configuration 32, until the game device 10 is triggered 34 (e.g. by activating a proximity sensor, such as with another object, such as a second game device encroaching within a proximity threshold). Upon triggering, the game device 10 is reconfigured to a second status or configuration 37.

Referring now to FIGS. 6a, 6b and 6c, there is schematically illustrated a sequence of possible operation of the device of FIG. 3, such as with the method of FIG. 5. Each game device 10a, 10b emits a short-range WiFi signal (Bluetooth™ here), indicated by the concentric rings 11a, 11b emanating from each respective game device 10a, 10b. The rings 11a, 11b are indicative of the 3D signal strength, lessening with increasing distance from each game device 10a, 10b. As shown here, the Bluetooth™ signal from each device 10a, 10b is similar, dissipating similarly in strength with increasing distance from the respective game device 10a, 10b. As shown initially in FIG. 6a, each game device 10a, 10b is sufficiently remote from the other game device 10b, 10a that there is no discernible signal detectable at the other game device 10a, 10b; or at least the signals are of insufficient strength to meet a threshold, such as associated with a proximity threshold. During the course of a game, the game devices 10a, 10b move, such as with the user/holder of the first game device 10a chasing the user/holder of the second game device 10b. Relative movement between the game devices 10a, 10b is schematically depicted in the transition from FIG. 6a to FIG. 6b. In FIG. 6b, the game devices 10a, 10b are relatively closer together. However, the distance is still too great for the other game device 10b, 10a to detect the Bluetooth™ signal; or at least the signals are of insufficient strength to meet the proximity threshold. As the game progresses, the chaser with the first game device 10a manages to get closer to the chased user/holder with the second game device 10b, as schematically depicted in the transition from FIG. 6b to FIG. 6c.

In at least some examples, the devices do not need to complete communication, such as by pairing following a Bluetooth handshake. Rather, the mere detection of the signal (another signal) of sufficient strength triggers the (each) game device 10a, 10b to determine that it is within the proximity threshold of another game device 10b, 10a. This trigger can be used to determine and optionally change the status or game role of the (each) game device 10a, 10b. For example, where the second game device 10b is initially in a “pursued” configuration/role, the status may change to that of chaser/pursuer upon detection of the signal of sufficient strength—such as when the first game device 10a is sufficiently proximal to the second game device 10b, as depicted in FIG. 6c.

In at least some examples, the first and second game devices 10a, 10b handshake and pair, such as to form a network (e.g. a WPAN), when the game devices 10a, 10b are sufficiently proximal (e.g. FIG. 6c). The game devices 10a, 10b can exchange data over the WPAN, such as relating to identity, status, game role, device parameters (e.g. power, history, points, etc.).

Accordingly it will be appreciated that the game devices 10a, 10b can be effectively smart-balls for use in chase-type games.

Referring now to FIGS. 7a, 7b, 7c and 7d, there is schematically illustrated a sequence of a possible operation of the array of devices 10a, 10b, 10c, 10d, 10e of FIG. 1. The basic principle of operation is generally similar to that depicted in FIGS. 6a, 6b and 6c. For example, the transition from FIG. 7a to FIG. 7b depicts a relative movement between the first game device 10a and the second game device 10b, with the second game device 10b changing status triggered by detection/receipt of the signal from the first device 10a being sufficiently proximal. Accordingly, it will be appreciated that the game devices 10a, 10b, 10c, 10d, 10e can be used to perform games, such as Group Tag/‘Last-man-standing’/Zombie tag. As with the example in FIGS. 6a, 6b and 6c, the devices may not need to pair or form a network in at least some games: the mere detection of a sufficient signal may be adequate for completion of the game, with the Bluetooth merely functioning as a proximity sensor. As shown here, the winner of the game can be the last game device 10e to remain in the initial configuration, being the last game device to remain sufficiently far away from any other game device 10a, 10b, 10c, 10d performing the chasing (e.g. the proximity sensor threshold of the Bluetooth receiver never being met for this game device 10e).

In other examples, the game devices 10a, 10b, 10c, 10d, 10e may form a network upon signal detection (e.g. a WPAN following Bluetooth pairing) and/or a WLAN (e.g. with a wireless network between the game devices 10a, 10b, 10c, 10d, 10e). For example, a game may operate with the following procedure/operation:
1. All players take a Ball 10a, 10b, 10c, 10d, 10e with an initial status, such as a same-colour (e.g. green illumination).
2. 3,2,1, GO!—One tagger is selected at random, such as by an external control device 36, or by the game devices 10a, 10b, 10b, 10d, 10e networked together (e.g. via a WLAN); and that selected game device changes status, such as to a different colour from the others (e.g. red illumination), such as depicted in FIG. 7a.
3. They run around and when the tagger 10a gets within proximity (around 1-2 m, depending upon predefined settings) of another player 10b, that other player is tagged—and their game device 10b also turns red and they become another tagger (e.g. FIG. 7b, 7c).
4. After some time there are many taggers and only one free person 10e left and they are the winner (e.g. FIG. 7d).

FIGS. 7e, 7f, 7g, 7h schematically illustrate a sequence of another possible operation of the array of devices of FIG. 1. Here, the game devices 10a, 10b, 10c, 10d, 10e are configured to change status upon triggering of the proximity sensor of each device 10a, 10b, 10c, 10d, 10e. As shown here, the operation of the game devices 10a, 10b, 10c, 10d, 10e is such that there is only a single chaser/tagger at any one time. Here, the game devices 10a, 10b, 10c, 10d, 10e exchange data: by Bluetooth pairing when proximal and/or WLAN. Accordingly, when the game device's proximity sensor is triggered, the game device 10a, 10b, 10c, 10d, 10e identifies the other game device 10a, 10b, 10c, 10d, 10e and determines the role/configuration of that other game device 10a, 10b, 10c, 10d, 10e. If the other game device 10a is the tagger/chaser (e.g. FIG. 7e), then the game devices 10b, 10c, 10d, 10e are being reconfigured to become the tagger/chaser and the original tagger/chaser 7a is reconfigured to become a pursued/chased role, such as illustrated in the transition from FIG. 7e to FIG. 7f; and subsequently in the transitions from FIGS. 7f to 7g and from 7g to 7h. In the operation shown here, if the other game device 10b, 10c, 10d, 10e in proximity is not the tagger/chaser, then the game devices 10b, 10c, 10d, 10e are not being reconfigured to become the tagger/chaser and the original tagger/chaser 10a remains configured as the tagger/chaser. It will be appreciated that where a WLAN is also utilised, in addition to the Bluetooth (functioning as proximity sensor), data may be exchanged between game devices 10 over the WLAN even when the game devices 10 are not sufficiently proximal to trigger the proximity sensor. The WLAN typically has a much greater range that the Bluetooth or other short-range signal for proximity sensing.

It will be appreciated that there can be a temporal aspect to the determination: for example, the proximity sensor needs to be triggered for a minimum length of time to complete reconfiguration of each game device 10a, 10b to its new status/rule. In at least some examples, the game devices 10a, 10b, 10c, 10d, 10e are configured to prohibit “tag-backs” (chasing/catching the immediately-preceding chaser/tagger) within a defined period, such as 30 seconds or 2 minutes—to allow the previous tagger/chaser to avoid being immediately re-tagged. The game devices 10a, 10b, 10c, 10d, 10e are configurable to entirely prohibit tag-backs in at least some game modes.

Accordingly an example game, such as a game of “knock-out tag”, may operate with the following procedure/operation:
1. All players take a game device 10a, 10b, 10c, 10d, 10e in an initial configuration (e.g. all with blue illumination).
2. 3,2,1, GO!—One tagger 10a is selected at random, such as by an external control device 36, or by the game devices 10a, 10b, 10b, 10d, 10e networked together (e.g. via a WLAN); and that selected game device 10a changes status, such as to a different colour from the others (e.g. red illumination), such as depicted in FIG. 7e.
3. They run around and when the tagger 10a gets within proximity (around 1 m, depending upon predefined settings) of another player 10b, that other player 10b is tagged—and their game device 10b turns red and they become the new, sole tagger (e.g. FIG. 7b, 7c), with the previous tagger 10a changing status to pursued (e.g. changes to blue illumination).
4. The new sole tagger 10b has 30 seconds to tag someone or they are out of the game for that round. The time limit to tag someone else reduces as the game progresses.

It will be appreciated that there can be more than one tagger/chaser. For example, in at least some configurable game modes, the game operates with at least two simultaneous taggers. The game devices 10a, 10b, 10c, 10d, 10e are also configurable for team operation; such as with two or more teams.

FIG. 8 schematically shows the device 10 of FIG. 1 in a user's hand. The game device 10 comprises a portable electronic game device, which is shown here as a handheld game device. The game device 10 is configured for gripping by the hand, with the housing 14 of the game device 10 comprising a relatively high coefficient of friction with skin, in both dry and wet conditions. In at least some examples, the housing 14 has a surface roughness and/or a water contact angle compatible with relatively high skin friction in wet and/or dry conditions. In this example, the game device 10 is configured to be held in one and/or two hands. When gripped by either one or both hands, a substantial portion/s of the game device 10 remains uncovered by the hand/s. The uncovered portion/s assist in permitting passage of light and/or sound from the game device 10.

As shown in FIG. 9, the uncovered, exposed portions of the game devices 10a, 10b enable a pair of users using the respective devices 10a, 10b to readily view the other's game device 10b, 10a. Accordingly, each user can easily view the status of the other's game device 10b, 10a, typically that of either a teammate or opponent—as generally visible from the status. Each user can also readily view their own respective gaming device 10a, 10b to check their own game status. In contrast to other devices, such as mobile phones or other devices with screens/displays, the present gaming devices 10a, 10b convey instantaneous information, without requiring reading of text, symbols or other complex information, or the like. Accordingly, the present gaming devices 10a, 10b encourage active movement of users, without inhibition or danger of diverting vision or attention whilst moving/running, etc.

FIG. 10 illustrates a group of users using a plurality of the devices. Here, the game devices 10a, 10b, 10c, 10d, 10e can be used in various, selectable game modes of operation, such as either of the game modes depicted in FIGS. 7a though 7d or FIG. 7e through 7h respectively; and optionally other games, such as described below.

FIG. 11 shows a pair of users using two of the devices at a water setting; The game device 10 here is waterproof, rated to at least IP68. It will be appreciated that the game devices 10 depicted here can effectively be used as “smart balls” for various games, including catch and pass games.

For example, a plurality of game devices 10 can be used for playing “proximity rugby” (or proximity American football, or handball or the like), such as along the following lines:
1. All participants take a game device 10, there is a first (e.g. blue illuminated) team and a second (e.g. green illuminated) team.
2. There is a line of game devices 310 for the first team (e.g. green smart balls) lying on the ground at one end of the play space and a line of game devices 310 for the second team (e.g. blue balls) at the other.
3. The players start at their home line. 3,2,1, GO!—One random player starts with possession—their game device is selected at random and changes status (e.g. their ball turns to red illumination).
4. They must get the selected game device (e.g. red ball) to the opposite side's home line.
5. On the way they can switch pass to other players in their team by getting into proximity: accordingly the selected game device 310 can effectively be passed—without physically passing the game device 310 as such (e.g. the match ball can be electronically ‘passed’ to teammates, without any physical exchange of game devices 310).
6. The selected game device 310, effectively the “match ball”, can be stolen/intercepted by the opposite team by getting into proximity of the selected game device 310 (e.g. red ball), at which time their game device 310 will become the selected game device, effectively the match ball (e.g. their ball will turn red).
7. A team can score a try by getting the selected game device 310 (e.g. red illuminated ball) to the home line of the opposing team.
   Other games may involve the plurality of game devices 10 used for playing “chaos orienteering” (or confusion orienteering, chaos/confusion tig/tag or the like), such as along the following lines:
1. Target game devices 310 (e.g. balls) are placed around the play space. Each target game device 310 has a different illumination (e.g. Red, Yellow, Blue, Green, etc.).
2. Each player must get in proximity of each target game device 310 to ‘collect’ all the colours (e.g. red, blue, green and yellow) then all and the first player to collect all colours wins.
3. As target game devices 10 (e.g. colours) are collected the quadrants of the players ball change to match the colours collected so they know what they need.
4. In at least some examples, the challenge is created by the fact that the target game devices 10 are changing their colour for every 3 players that taps on it so you might not get the colour you expect.
   Other games may involve the plurality of game devices 10 used for playing blindfolded tig/tag or the like (historically called “blind man's buff”), such as along the following lines:
1. One player is selected as the tigger/tagger and is blindfolded and equipped with a game device 10 (e.g. match ball).
2. The other players hold their game devices 10 (e.g. target balls) and try to evade the blindfolded tigger/tagger. The other players game devices 10 occasionally emit a small sound at random to aid the blindfolded tigger/tagger in locating the others.
3. When the blindfolded tigger/tagger gets sufficiently close to another player, the respective game devices' 10 proximity sensors are triggered, and the blindfolded tigger/tagger has caught them and the game is finished and that person becomes the new blindfolded tigger/tagger.
   Other games may involve the plurality of game devices 10 used for playing “minefield” type games, such as along the following lines:
1. A large array of game devices 10 (e.g. configured as blue balls) are laid out on the ground. One game device 10 (e.g. configured as a yellow ball) is selected as the ‘treasure’ in the middle.
2. Players must pick their way through the array of game devices 10 (e.g. blue balls) and get to the treasure game device 10 (e.g. yellow ball) in the centre without setting off one of the ‘mines’ (other game devices 10, such as the blue balls)—by getting too close to a ‘mine’ (e.g. avoiding getting within the proximity threshold of the ‘mine’ game devices—blue balls). In at least some examples, the ‘mines’ game devices 10 are not illuminated so that no one knows which is live or not—or the ‘mines’ game devices 310 could change to not all being activated at the one time meaning that a player must run through the temporarily clear zone to reach the target game device 310 in the centre.

FIG. 12 shows a single user using a pair of the devices 10a, 10b to play effectively a solo game, although the second game device 10b may have been hidden by another person (not shown). It will be appreciated that such a hunt-type game may be played solo or by multiple players. For example, an example treasure hunt game could be played with multiple game devices 10 as follows:
1. One player hides some red ‘Treasure’ balls 10b.
2. Other players enter the play space and must find and move their ball 10a to be proximal to each of the treasure balls 10b.
3. Once all the treasure balls 10b are ‘found’ that player wins.
4. The treasure balls 10b could emit a small sound to aid in locating based on conditions such as the proximity of the seeker (e.g. frequency of beeping increasing with increasing proximity of player's ball 10a).
5. The players balls 10a could glow red when they get close to a treasure ball in a warmer/colder type of way. In at least some examples, the player's ball 10a emits spoken text to say “warmer” or “colder” to aid that ball's user—and optionally also notify/alert other players to a possible location of a treasure ball 10b.
6. Optionally, the treasure balls 10b may need to be ‘found’ sequentially.

It will be appreciated that other games may be played entirely solo with a single game device 10. For example, a single game device 10 may be configurable to play games requiring the user/player to perform actions; especially actions in a particular sequential order. For example, the game device 10 may instruct the user to perform one or more of: “shake”, “twist”, “throw”, “run”, “bounce”, “jump”, “spin”, etc. The game device may emit audio and/or haptic and/or visual instructions. For example, a particular colour of the game device may correspond to a particular action (e.g. game device changing to a first colour, or flashing a first colour, or colour sequence, may correspond to a first action, such as “shake”, and a second colour signal may correspond to a second action, such as “throw”). The instructions may be multimodal (e.g. an audio instruction may accompany a corresponding visual and/or haptic instruction signal).

FIG. 13 shows a group of users using a plurality of the devices 10b, 10c, 10d, 10e in a wearable configuration; worn here on the user's arm. Noting that in other examples the game devices 10b, 10c, 10d, 10e may be otherwise worn (e.g. on a leg, torso, in a pocket, bag or the like). The game device may be attachable. The game device may be attachable with an accessory, such as a strap, band, garment or the like (not shown). Here, the game may involve a version of proximity rugby, American football, handball or the like. For example, a player with the game ball 10a may be effectively ‘tackled’ by an opposing team player coming sufficiently close to trigger the proximity sensor of the game ball 10a and/or the ball's possessor's game device (e.g. game device 10b as shown in FIG. 13). The player in possession may then receive an indication they have been tackled (e.g. visual and/or haptic and/or audio signal from the game ball 10a and/or their own worn game device 10b); and that player may then have a limited time in which to try to pass the game ball 10a to a teammate. Possession may be won by the opposing team by intercepting the thrown game ball 10a and/or of the game ball 10a is dropped and/or if a certain number of ‘tackles’ are completed; and/or if a “tackled” player is unable to complete a successful pass within the limited time (which may be determined by the game ball 10a and/or other game devices 10b, 10c, 10d, 10e). A proximity “tackle” may be defined or interpreted as a “tackle” similarly to other sports, such as rugby league, American football, handball, or any other sport.

In at least one example, the game devices 10a, 10b, 10c, 10d, 10e may be used in a version of “dodgeball”, with a general outline of play as follows:
1. Each player wears a ball 10 on their wrist or armband (see e.g. FIG. 13).
2. Other players target the original players with another thrown ball and if the ball passes sufficiently close that player is “caught”, or co-opted to the team or similar.
3. In at least some examples, the targets for the throwing player could change dynamically to add interest.

FIG. 14 shows another example of a device 110, generally similar to the device 10 shown in FIG. 1, with similar features denoted by similar reference numerals incremented by 100. Accordingly the device 110 comprises a core module 112 and a housing 114, with description of every feature not being duplicated here for brevity. As shown here, the core module 112 forms a greppable handle, protruding belong the spherical housing 114, even when assembled. Accordingly, when gripped, substantially an entirety of the surface of the housing 114 is visible, around 360° laterally and from above. FIG. 15 shows a schematic layout of components of the device of FIG. 14, with LEDs 118 for light emission along with an audio speaker 120; and also a rechargeable battery 126, vibration transducer 124; and a control PCB 122 which houses gyro/s and accelerometer/s for detecting orientations and movements of the game device 10 and memory, Bluetooth™, wifi components. In the example shown here, electrical contact pins 128 are provided for charging the battery 126. In this, and other, example, re/charging of the game device 110 does not require any disassembly, such as disconnection of the core module 112 from the housing 114.

FIG. 16 shows another example of a device 210, here shown as a generally cubic device, smaller than that shown in FIGS. 1 and 14. The device 210 shown in FIG. 16 is more similar to that of FIG. 14 than FIG. 1, in that the device 210 here effectively comprises a single unit not disassemblable or disconnectable in use into discrete housing and core components. The device 210 comprises similar functionality to that of those shown in FIGS. 1-15.

FIG. 17 shows the device of FIG. 16 schematically incorporated in an article 240a, shown here as a plush or cuddly toy, such as a teddy bear. The article can be used for playing games, such as the treasure hunt described above; or shown in FIG. 12. It will be appreciated that the article 240a can be solid, so as effectively not to emit any illuminated light from the device 210. In such examples, the device may provide indications to users at least primarily via audio and/or haptic output from the game device 210. In addition, or alternatively, the location or proximity of the article 240a or game device 210 can be indicated with the output from another game device (not shown in FIG. 17). For example, the article may be used in games such as the treasure hunt described above, or shown in FIG. 12. In at least some examples, the article can be at least partially transmissive, or even partially translucent, semi-transparent or even transparent. The article 240a here is configured for receiving the game device 210, such as with a suitably sized and dimensioned compartment, optionally closable. In some examples, the article 240a comprises an appropriate interface/s for output/s from the game device 210, such as a transparent window/s and/or apertures for light and sound transmission respectively. In at least some other examples, the article 240a is an existing article already possessed or otherwise obtained by the user.

FIG. 18 shows the device of FIG. 16 schematically incorporated in another article 240b, shown here as a rugby ball. The article can be used to play any of the games described above, such as any of the tig/tag/chase games; or any other games. For example, the article 240b in the form of the rugby ball is particularly suitable for the above described “dodgeball” or “proximity rugby”. The rugby ball article 240b effectively provides an additional protective housing for the game device 210. Accordingly, the game device 210 may be even better able to withstand shocks, accelerations associated with being thrown, kicked, dropped or otherwise physically manipulated than in at least some other examples. In at least some examples, the protection provided by the article 240b can replace that of a separate or separable housing 14 of the game device 210, with effectively only a core module provided as the game device 210 in the article 240b.

FIG. 19 shows the device of FIG. 16 schematically incorporated in another article 240c, shown here as a soccer ball. The article 240c may be particularly suited to games where a single player does not continuously hold the game device 210, such as involving throwing, catching, kicking, floating, rolling, bowling or the like.

The articles 240b, 240c of FIGS. 18 and 19 may comprise similar properties to the article 240a of FIG. 17. For example, in at least some examples of the articles 240n, 240c of FIGS. 18 and 19, they are at least partially transmissive, or even partially translucent, semi-transparent or even at least partially transparent. For example, at least some of the panels of the rugby ball 240b and/or soccer ball 240c may be transparent. It will be appreciated that the articles 240a, 240b, 240c here have securable openings to insert and remove the game devices 240a, 240b, 240c as required, such as for charging. In other examples, the game devices 240a, 240b, 240c are at least semi-permanently secured within the articles 240a, 240c, 240c.

FIG. 20 shows another example of a device 310, generally similar to the device 210 shown in FIG. 16, with similar features denoted by similar reference numerals incremented by 100. Accordingly the device 310 comprises a housing 314 and LEDs 318, with description of every similar feature not being duplicated here for brevity. The game device 310 here is waterproof, rated to at least IP68. The device 310 functions similarly to preceding examples, with a proximity sensor (e.g. Bluetooth), gyro/s, accelerometer/s and audio and haptic outputs (as well as visual from the LEDs 318). The device 310 here is a torus or ring-shape, with an open hole 360 in the centre; and the housing 314 (with internal core module 312) extending fully around the entire circumference of the opening 360.

The device 310 here is configured for aquatic use, particularly in swimming pools or sea water. The device 310 has a pair of textured, profiled rubber grip sections 319 to encourage gripping at these particular portions of the device. Gripping the device here assists in maintaining intermediate portions of the ring of the device (e.g. on right hand edge and left hand edge as shown in FIG. 20) free from coverage by hands. Accordingly, signal emission from these portions may be enhanced or at least unimpeded. For example, visual and/or audio game device status signals may be readily emitted from these portions of the device 310. Additionally or alternatively, one or more of the device's antennae (e.g. for WiFi and/or Bluetooth) may be at least partially located in these exposed, uncovered, non-grip sections so as to reduce or at least mitigate any shadow effect/s associated with a user's hand/s. It will be appreciated that the devices 10, 110, 210, 310 could each be used in modes of operation as disclosed for any other example, embodiment, claim or aspect as described herein. Accordingly, the device 310 shown in FIG. 20 may be configurable for use in proximity rugby, tig or any other suitable game. Where the device 310 here is a ring-shape, configured for aquatic use, it will be appreciated that those games may also be played in an aquatic setting (see e.g. FIG. 22). The ring-shape may assist in single- and/or double-handed gripping in at least some instances; and/or particular modes of use, such as particular throwing games (e.g. quoits, Frisbee™-type games, etc.).

FIG. 21 shows an accessory 350 for use with the device 310 of FIG. 21. Here, the accessory 350 is a floatation aid for selectively attaching to the game device 310. The accessory 350 has openings or notches 354 for selectively securing the accessory 350 to the game device 310. The accessory 350 here also includes visual instructions for at least one particular game or use of the accessory 350 in combination with the game device 310. In at least some examples, the float may comprise an identifier, such as bar code, QR code, RFID or other tag. The identifier may be used to automatically configure that game device 310 attached to the accessory 350 for performance of that game. For example, the accessory 350 may comprise a tag automatically detectable by the game device 310 when the accessory 350 and game device 310 are in very close proximity (e.g. less than 50 cm, or even less than about 10 cm in some examples). In at least some examples, the identifier 352 is scannable by the game device 310 and/or an external control device 36, such as that shown in FIG. 2. Here, where the accessory 350, when attached to the game device 310, provides the game device 310 with additional positive buoyancy, then that combined accessory 350 and game device 310 may be particularly suited to games involving floating game devices. For example, the game device 310 may be positioned remotely in a body of water (e.g. by placement or safely throwing, etc.); and the user/player may have a limited time to retrieve the game device 310 to complete the challenge, or earn a point or reward. Accordingly, it will be appreciated that the game device 310 can be used as a single standalone device for solo play. In addition, multiple players may be able to play games with the single game device 310, such as sequentially and/or simultaneously seeing which player can retrieve the game device 310 within the shortest time.

FIG. 22 shows an array of the devices 310 of FIG. 20 in use in a water setting. As well as being able to perform games as described elsewhere, the game device 310 may be configurable for use in a class or group arrangement or network. The game devices 310 may all be similarly configured to each other, such as to provide similar outputs or feedback in response to particular movements or actions, such as defined actions or movements performed in a particular time frame or window. Alternatively, at least one of the game devices 310 may be configured as a master game device 310, such as that of a teacher or instructor. The master game device 310 may effectively transmit instructions to the other game devices 310, such as over a WLAN to which all of the game devices 310 are connected. Accordingly, the game devices 310 may receive advance and/or contemporaneous instructions, such as for the game device 310 to perform a particular action or function. For example, following a defined action or movement of the master game device, the other game devices 310 may receive WLAN or WPAN signal/s detailing the action or function, such as providing a limited time period or window for the user to complete the action or function, with the game device's gyro/s and/or accelerometer/s detecting absolute or relative success in completion of the action or function within the time period or window. Feedback on the action or function may be provided, such as directly to the user (e.g. visual/audio/haptic feedback) and/or indirectly, such as communicated over the WPAN or WLAN to the master device and/or an external control device; and/or retrospectively retrieved from the memory of the game device/s 310 and/or the external control device.

FIG. 23 shows the array of the devices 310 of FIG. 22 in use and also stored with accessories 350a, 350b, 350c, 353 in a storage structure 370. The storage structure 370 here is a portable storage structure, on wheels, for conveniently transporting a multiplicity of the game devices 310 together to and around the pool setting. Different types of accessory 350, 353, 354 can provide different adaptations of the game devices 310. A same type of accessory, such as the floating accessory 350, may be provided in several configurations 350a, 350b, 350c—such as for performing different games or modes with the game device 310. For example, a first floating accessory 350a may comprise instructions (visually and/or electronically, such as via a scannable identifier) for a first floating game; whilst second and third floating accessories 350b, 350c may comprise instructions (visually and/or electronically, such as via a scannable identifier) for respective second and third floating game.

FIG. 24 shows a plurality of the devices of FIG. 20 together with a plurality of the accessories of FIG. 21. Here several game devices 310 and accessories 350 350, 353 have been connected together to form a floating ring shape 357 for use in specific games. The physical interconnectability of the accessories 350, 353, 354 may provide an intrinsic gameability, particularly for younger users, enabling the game devices 310 and/or accessories 350, 353, 354 to be used effectively as a construction toy.

FIG. 25 shows the device 310 of FIG. 20 together with another accessory 354. Here, the accessory 354 when assembled with the game device 310 (by simple reversible snapfit) provides the game device 310 with increased resistance to movement, particularly through water. Accordingly, the accessory 354 effectively converts the game device 310 to a drag game device 310, which may be particularly suited to specific games and/or exercises in water. For example, the accessory 354 may be particularly suited to games or movements, such as for improving swimming, diving and/or cardiovascular exercise.

FIG. 26 shows the device of FIG. 20 together with another accessory 356. Here, the accessory 356 when assembled with the game device 310 (by simple reversible snapfit) provides the game device 310 with increased resistance to movement, particularly through water; and also increased positive buoyancy. Accordingly, the accessory 356 effectively converts the game device 310 to a floating drag game device 310, which may be particularly suited to specific games and/or exercises in water. For example, the accessory 356 may be particularly suited to games or movements, such as for improving swimming, diving, cardiovascular exercise and/or aerobic exercise.

FIG. 27 shows the storage structure 370 of FIG. 23 together with a plurality of the devices of FIG. 20 and a plurality of the accessories of FIG. 21. The storage structure 370 is configured to store the multiplicity of game devices 310 together. This particular example 370 is configured to store the game devices 310. In at least some examples, the storage structure is configured to electrically charge the multiplicity of game devices 310.

FIG. 28 shows a similar storage structure 372 to that 370 of FIG. 27. The storage structure here 372 is configured to store and transport the multiplicity of game devices 310 together. This particular example 372 is configured to transport, store and electrically charge the game devices 310. The storage structure 372 can be readily transported away from the water setting to an electricity connection point (e.g. mains socket), where the storage structure 372 has an electrical connection for charging the multiplicity of game devices 310 simultaneously (e.g. via induction charging or electrical connection pins located on the respective storage hooks or arms for each game device 310).

FIG. 29 shows a schematic of a mode or game of use of the device 310 of FIG. 20. Here the game device 310 is schematically illustrated as a baton, although it will be appreciated that the game can be played with the ring-shaped game device 310 of FIG. 20. It will also be appreciated that in at least some examples, the game device 310 may be provided in a baton form—such as that schematically shown in FIGS. 29-35. The gamer depicted in FIG. 29 requires the user to perform a specified action within a certain time period. For example, an audio instruction of “lift”, “dunk”, “push”, “swivel clockwise”, “swivel anti-clockwise” may be sequentially issued by the game device 310, with the user required to perform the instructed action with a defined time window after that respective audio instruction. The performance of the action may be detected by the game device's gyro/s and/or accelerometer/s. The game may progress with increasing complexity of instructed actions and/or shortening of time windows and/or requiring increasing accuracy of movement. The sequence and/or parameters (e.g. time windows and/or accuracy and/or development/progression thereof) may remain the same in consecutive games. Alternatively, at least the sequence of instructions may vary in consecutive games (e.g. “dunk” may be first instruction, then “swivel clockwise”, then “lift”, etc.). Points may be awarded for each correctly-performed action. A game may be ‘lost’ or ended when the user fails to satisfactorily perform the instructed action within the required time window. Feedback of the instructed action and/or indication of successful completion thereof and/or a points tally, etc. may be indicated visually (e.g. colour or colour change of game device 310) and/or audially (e.g. beep or spoken word, etc.) and/or haptic (e.g. number of vibrations corresponding to a particular action or score). This game can be performed solo, with a single user with at least one game device 310 (optionally multiple game devices 310, such as one in each hand). Additionally, or alternatively, this game can be performed with a group, such as with multiple game devices 310 connected in a WPAN, WLAN or similar.

FIG. 30 shows a schematic of a further mode or game of use of a plurality of the devices 310 of FIG. 20. Here the game is a form of mine racer whereby each game device 310 changes status (e.g. colour) if it is not retrieved/neutralised within a certain predefined time period. The game device may detect retrieval/neutralisation with one or more of its sensors. For example, neutralisation may be detected by a sufficient change in orientation of the game device detected by one or more gyro/s or an accelerometer/s. The game can be played with a single player or with multiple players and optionally multiple teams, particularly when multiple game devices 310 are used together. The game can be initiated here with an action involving the game devices 310, such as tapping the game devices 310 together.

FIG. 31 shows a schematic similar to that of FIG. 30 of a further mode or game of use of a plurality of the devices 310 of FIG. 20. Here, the game is a music-based game (e.g. “Beat It”), with audio instructions being provided in the form of a particular note or sound, each note or sound corresponding to an associated action. As shown here, a single user can perform the game with multiple game devices 310 (e.g. a pair) with the absolute and/or relative movement of each game device 310 determining a sufficiency of completion of each action, which may be rated on a scale (e.g. from “nice” to “excellent” or similar) dependent on conformance within tolerance windows. The level of difficulty can be varied, such as increasing difficulty by reducing acceptable tolerance of movements/actions and/or reducing time interval for performing suitable movement/actions. It will be appreciated that multiple users could perform the same game simultaneously, with each user's game devices being networked locally, for example; and/or the audio instructions (e.g. sounds/notes/music) being provided centrally, such as by a master game device 310 and/or an external control device.

FIG. 32 shows a schematic similar to that of FIG. 29 of a further mode or game of use of a plurality of the devices 310 of FIG. 20. Here, the selected game mode is of a treasure hunt similar to that described above (e.g. w.r.t. FIG. 12). As shown here, the game devices 310 have been configured to sink (e.g. with an accessory 353, or otherwise). In other examples, the game devices 310 for the treasure hunt may comprise a positive buoyancy (e.g. with aid of an accessory 350, 356); a neutral buoyancy; or a mixture of floating and sunk game devices 310 with the game devices 310 being retrieved or ‘found’ at their surface or submerged locations. It will be appreciated that, in addition or as an alternative to audio instruction, the instructions as depicted in FIG. 30 may be conveyed to the user/s in printed form, such as on an accessory 350 and/or an instruction card and/or viewable on a screen, such as via an external control device (noting that the game device 310 is expressly screen-less).

FIG. 33 shows a schematic similar to that of FIG. 30 of a further mode or game of use of a plurality of the devices 310 of FIG. 20. Here, the game is a type of “capture-the-flag” whereby the aim of each team is to retrieve all of the game devices 310 of a single team to within proximity of their team's master game device 310a. The winning team is that which retrieves all of the designated game devices 310 (e.g. by colour) first. Each master game device 310a can determine whether the other game devices 310 (of correct team/colour) are within sufficient proximity. Variations of the game can include “flag defenders”, whereby if a user from another team (carrying or wearing a game device 310 set for that another team) is ‘tackled’ by a defender (e.g. defender with game device 310 of opposing team manages to get within sufficient proximity of that user).

FIG. 34 shows a schematic similar to that of FIG. 29 of a further mode or game of use of a plurality of the devices 310 of FIG. 20. Here, rather than an individual game device 310 issue a sequence of instructions or actions to be sequentially followed, the sequence of actions to be followed is indicated by a plurality of game devices 310. For example, the networked game devices 310 can light up or change colour (and/or provide other indication, such as audibly) sequentially. The user is then required to retrieve or perform an action with each game device 310 in the sequence indicated—requiring the user to remember the sequence and then perform the actions (e.g. retrieval) in the correct order within a defined time window/s.

FIG. 35 shows a schematic similar to that of FIG. 34 of a further mode or game of use of a plurality of the devices 310 of FIG. 20. Here, rather than a sequence in order, the user is required to remember which game devices 310 were initially shown in which colour; and tries to group all game devices of a same colour together (when the game devices 310 colour has become non-illuminated). The game can effectively be similar to pelmanism card game, with variations allowing more than two variations (e.g. with three colours rather than the two shown in FIG. 35); and/or solo or team play and/or with floating/sunk game devices 310.

It should be understood that the embodiments described herein are merely exemplary and that various modifications may be made thereto without departing from the scope of the invention. For example, where the game device is shown as a spherical object held in one hand, other embodiments may comprise different shapes and holding configurations, such as annular or wearable.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as disclosed in any aspect, example, claim or embodiment of this disclosure, and a machine-readable storage storing such a program. Still further, embodiments of the present disclosure may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims, including with equivalence as appropriate.

1. A portable handheld screenless electronic game device comprising at least one proximity sensor, the proximity sensor being configured to detect a proximity of the game device to an object and/or to detect a proximity of the object to the game device, such that the game device is configured to detect a relative proximity between the game device and the object, wherein the game device is configured to change game state or configuration in dependence on a proximity trigger signal, the proximity sensor providing the proximity trigger signal when the object is detected within a minimum threshold relative proximity to the game device; and wherein the object comprises a second portable handheld screenless electronic game device, such that a first game device is configured to detect a proximity of a second game device relative to the first game device, with the first game device being configured to change game state or configuration in dependence on the proximity detection; wherein the game device is configured to emit light omnidirectionally.

2. The game device of claim 1, wherein the minimum threshold comprises a distance range of the game device and a temporal element, whereby the minimum threshold comprises the object being within a minimum distance range of the game device for a minimum length of time.

3. The game device of claim 1, wherein the game device comprises a discrete electronic device configured for use only in proximity-based games, the proximity-based games being dependent on the physical proximity of the actual device relative to the object; and wherein the game device is devoid of a graphical user interface.

4. The game device of claim 1, wherein the game device comprises a movement or motion sensor; and wherein the game device is configured to change game state or configuration in dependence on a trigger event, the trigger event comprising a movement or action with or on the game device, such as a change in orientation of the game device.

5. The game device of claim 1, wherein the proximity threshold is configurable or reconfigurable, such as in dependence on one or more of: a game or type of game being played; and/or a role and/or phase in the game being played with the device.

6. The game device of claim 5, wherein the proximity threshold is configured to vary automatically, such as in dependence upon a variation in game and/or role; and also wherein the proximity threshold is manually adjustable, such as by a user or a master user/controller.

7. (canceled)

8. An array of game devices according to claim 1, the array comprising at least a first game device and a second game device, wherein the first game device is configured to detect a proximity of the second game device when it is within the proximity threshold of the first game device; and wherein the second game device is configured to detect the first game device when it is within a second proximity threshold, the second proximity threshold being associated with the second device.

9. The array of game devices of claim 8, wherein the proximity threshold of the first device and the second proximity threshold of the second device are the same, such as where the proximity threshold of both devices is configured to be triggered by a same signal strength and/or relative distance therebetween.

10. The array of game devices of claim 8, wherein the first and second game devices are configured to be triggered differently, such as whereby the first and second proximity thresholds are different.

11. The array of game devices of claim 8, wherein the proximity detection comprises an identification element and mutual proximity detection by both the first and second game devices prior to performing an action based upon the proximity trigger; and wherein a role and/or score of each device is dependent upon a proximity event and the game devices are each configured to perform mutual proximity detection to ensure synchronised triggering of each device simultaneously.

12. (canceled)

13. The array of game devices of claim 8, wherein the status or configuration of each game device is indicated by one or more of: visually indicated; an emission of light; audio and/or haptic indication; continuously indicated; temporarily or periodically indicated.

14. The array of game devices of claim 8, wherein each game device if configured for use without requiring any display or screen-based feedback, such as via an external device.

15. The array of game devices of claim 8, wherein the first game device is configured to be locally networked, such as with the second game device and optionally an external device.

16. The game device of claim 1, wherein the game device comprises a round, handheld form for gripping by a single hand, selected from one of: a torous form; and a spherical form; and the game device is configured to be thrown.

17. (canceled)

18. The game device of claim 1, wherein the game device is configured to emit different colours of light in dependence on the state or configuration of the game device, with the emitted colour varying as the game device status or configuration changes.

19. (canceled)

20. The game device of claim 1, wherein the game device is configured to be used in one or more of: an indoor setting; an outdoor setting; a swimming pool.

21. The game device of claim 1, wherein the game device is configured to be incorporatingly housed in an article, wherein the article is one or more of: a pre-existing household article; at least partially transmissive for light and/or sound; partially translucent, semi-transparent, or transparent.

22. The game device of claim 1, wherein the game device is configurable to be used in multiple modes of operation, the modes of operation selected from one or more of: “copycat” type game mode; “treasure hunt” game mode; blindfold games; standard games; night-time games; chase-type games; tag or tig; ‘Last-man-standing’; Zombie tag; proximity rugby; proximity American football; proximity handball.

23. The game device of claim 1, wherein the game device comprises an aerial for proximity sensing, the aerial being located within the game device such that the aerial is not masked by a user when the user holds or uses the game device.

24. A wearable screenless electronic game device comprising at least one proximity sensor, the proximity sensor being configured to detect a proximity of the game device to an object and/or to detect a proximity of the object to the game device, such that the game device is configured to detect a relative proximity between the game device and the object, wherein the game device is configured to change game state or configuration in dependence on a proximity trigger signal, the proximity sensor providing the proximity trigger signal when the object is detected within a minimum threshold relative proximity to the game device; and wherein the object comprises a second wearable screenless electronic game device, such that a first game device is configured to detect a proximity of a second game device relative to the first game device, with the first game device being configured to change game state or configuration in dependence on the proximity detection; wherein the game device is configured to emit light omnidirectionally.
